(19) United States
(12) Patent Application Publication
(10) Pub. No.: US 2020/0134648 A1
(43) Pub. Date: Apr. 30, 2020

(54) METHODS AND SYSTEMS FOR PREVENTING USER CHURN

(71) Applicant: BEIJING DIDI INFINITY TECHNOLOGY AND DEVELOPMENT CO., LTD., Beijing (CN)

(72) Inventors: Licai QI, Beijing (CN); Hengzhi WANG, Beijing (CN)

(73) Assignee: BEIJING DIDI INFINITY TECHNOLOGY AND DEVELOPMENT CO., LTD., Beijing (CN)

(21) Appl. No.: 16/726,351

(22) Filed: Dec. 24, 2019

Related U.S. Application Data
(63) Continuation of application No. PCT/CN2018/096789, filed on Jul. 24, 2018.

(30) Foreign Application Priority Data
Jul. 24, 2017 (CN) 201710608121.8

(51) Int. Cl. G06Q 30/02; G06N 7/00

(52) U.S. Cl. CPC G06Q 30/0202; G06N 7/005

(57) ABSTRACT

Methods and systems are provided for preventing user churn. The method may include retrieving historical data associated with a first plurality of users. The method may also include, for each user of the first plurality of users, determining a first feature vector of the user based on the historical data associated with the user, and determining a churn probability of the user by inputting the first feature vector of the user into a prediction model. The method may further include, for each user of the first plurality of users, assigning, based on the determined churn probability of the user, the user to one of a plurality of predetermined groups, each of which is associated with a user retention strategy. The method may also include, for each user of the first plurality of users, determining a user retention operation for the user based on the user retention strategy associated with the predetermined group that the user is assigned to, and performing the user retention operation on the user.

### CROSS REFERENCE

This application is a Continuation of International Application No. PCT/CN2018/096789, filed on Jul. 24, 2018, which claims priority of Chinese Application No. 201710608121.8 filed on Jul. 24, 2017, the entire content of each of which is hereby incorporated by reference.

### TECHNICAL FIELD

The disclosure relates generally to the field of user relationship management, and more specifically to methods and systems for preventing user churn.

### BACKGROUND

With the rapid development of the internet and mobile technology, drivers have become accustomed to accept driving service requests via mobile applications, while users also tend to send driving service requests via mobile applications. As the driving service related platforms are developing rapidly, due to market competition, users may churn for alternative driving service platform, leading to an unstable market share. Therefore, user churn prediction is necessary and important. Firstly, the user churn prediction may assist a driving service platform to understand its users better and to adopt different marketing and retention strategies for different user groups for increasing the retention rate of users. Secondly, the user churn prediction may enhance or maintain the user activity of a driving service platform and help to win the market.

Therefore, how to predict user churn and retain the churned users has become an important technical issue to be addressed.

### SUMMARY

According to an aspect of the present disclosure, a method for preventing user churn is provided. The method may include retrieving a sample group including users associated with a program or a mobile application and historical data corresponding to the sample group. The method may also include determining a plurality of feature parameters of the users based on the historical data, and labeling each user in the sample group based on at least one of the plurality of feature parameters of the user. The method may further include obtaining a prediction model for predicting a user churn probability by training a preliminary prediction model via a machine learning routine using at least some of the plurality of feature parameters and the labeled users of the sample group. The method may also include determining a churn probability of a test user by inputting a plurality of feature parameters of the test user into the prediction model, and determining whether to execute a predetermined user retention strategy on the test user based on the determined churn probability.

In some embodiments, the determining whether to execute one or more predetermined user retention strategies on the test user may include determining a probability threshold, and determining whether the churn probability of the test user is higher than or equal to the probability threshold; upon a determination that the churn probability of the test user is higher than or equal to the probability threshold, identifying the test user as a churned user, and transmitting data related to a predetermined user retention strategy to retain a churned user to the test user.

In some embodiments, the method may further include, after the determining a probability threshold and before the determining whether the churn probability of the test user is higher than or equal to the probability threshold: obtaining a first negative sample group by applying the prediction model to the users of the sample group; labeling users of the sample group other than the first negative sample group as a first positive sample group; determining an accuracy and a recall of the prediction model with respect to the identification of churned users based on the first negative sample group, the first positive sample group, a second negative sample group, and a second positive sample group; and determining a performance of the prediction model based on the determined accuracy and recall of the prediction model. The first negative sample group may be formed by users identified as churned users in the sample group. The second negative sample group may be formed by users of the sample group labeled as churned users during the labeling each user included in the sample group based on at least one of the plurality of feature parameters of the user. The second positive sample group may be formed by users of the sample group labeled as non-churned users during the labeling each user included in the sample group based on at least one of the plurality of feature parameters of the user.

In some embodiments, the at least one of the feature parameters of the user may relate to service requesting activities of the user, and the labeling each user in the sample group based on at least one of the plurality of feature parameters of the user may include: determining a reference time, and detecting, according to the at least one of the plurality of feature parameters related to service requesting activities of the user, whether the historical data associated with the user relates to any service requesting activity initiated by the user during a first predetermined time period before the reference time; upon a detection that the historical data associated with the user relates to any service requesting activity occurred during a first predetermined time period before the reference time, detecting, according to the at least one of the plurality of feature parameters related to service requesting activities of the user, whether the historical data associated with the user relates to any service requesting activity occurred during a second predetermined time period after the reference time; upon a detection that the historical data associated with the user relates to any service requesting activity occurred during a second predetermined time period after the reference time, labeling the user as a positive sample; and upon a detection that the historical data associated with the user does not relate to any service requesting activity occurred during a second predetermined time period after the reference time, labeling the user as a negative sample.

According to another aspect of the present disclosure, another method for preventing user churn is provided. The method may include retrieving historical data associated with a first plurality of users. The historical data may relate to user activities initiated by the first plurality of users during a predetermined time period. The method may also include, for each user of the first plurality of users, determining a first feature vector of the user based on the historical data associated with the user, and determining a churn probability of the user by inputting the first feature vector of the user into a prediction model. The method may further include, for each user of the first plurality of users, assigning, based on the determined churn probability of the user, the user to one of a plurality of predetermined groups, each of which is associated with a user retention strategy. The method may also include, for each user of the first plurality of users, determining a user retention operation for the user based on the user retention strategy associated with the predetermined group that the user is assigned to, and performing the user retention operation on the user. The user retention operation may include providing one or more promotions to use the online-to-offline service via a user interface of an online-to-offline service application implemented in a terminal device of the user.

In some embodiments, the method may further include, for each of one or more of the plurality of predetermined groups: determining a second plurality of users previously assigned to the predetermined group; determining, for each user of the second plurality of users, a change indicator of the user, the change indicator representing a change of churn risk of the user; and updating the user retention strategy associated with the predetermined group based on the change indicators of the second plurality of users and one or more performance thresholds.

In some embodiments, the change indicator may represent a change of the group of the user.

In some embodiments, the change indicator may represent a change of the churn probability of the user.

In some embodiments, the second plurality of users may be included in the first plurality of users.

In some embodiments, the updating the user retention strategy associated with the predetermined group based on the change indicators of the second plurality of user and one or more performance thresholds may include: determining a first performance parameter of the user retention strategy associated with the predetermined group based on the change indicators of the second plurality of users; comparing the first performance parameter with the one or more performance thresholds; and updating the user retention strategy based on the comparison results.

In some embodiments, the user retention strategy may include one or more user retention operations, and the updating the user retention strategy based on the comparison results may include replacing at least one user retention operation in the user retention strategy associated with the predetermined group using another user retention operation.

In some embodiments, the updating the user retention strategy associated with the predetermined group based on the change indicators of the second plurality of users and one or more performance thresholds may include: determining, for each of a plurality of previously performed user retention operations associated with the predetermined group, a second performance parameter of the previously performed user retention operation based on the change indicators associated with the previously performed user retention operation; selecting, from the plurality of previously performed user retention operations, at least one target user retention operation based on the second performance parameters and the one or more performance thresholds; and replacing at least one user retention operation in the user retention strategy associated with the predetermined group using the at least one target user retention operation.

In some embodiments, the assigning, based on the determined churn probability of the user, the user to one of the plurality of predetermined groups may include: determining one or more probability thresholds; comparing the determined churn probability of the user with the one or more probability thresholds; and assigning the user to one of a plurality of predetermined groups based on the comparison result.

In some embodiments, the method may further include: determining at least one performance indicator of the prediction model; determining a target range for the at least one performance indicator; and adaptively adjusting the one or more probability thresholds, so that the at least one performance indicator is within the at least one target range.

In some embodiments, the at least one performance indicator may include at least one of an accuracy, a precision, or a recall of the prediction model.

In some embodiments, the method may further include: retrieving historical data related to user activates of a plurality of sampled users. The method may also include, for each user of the plurality of sampled users, determining, a plurality of first feature parameters and at least one second feature parameter of the user based on the historical data, and assigning a label to the user based at least on the at least one second feature parameter. The plurality of first feature parameters may form a second feature vector of the user. The method may further include obtaining the prediction model by training a preliminary prediction model using the second feature vectors of the plurality of sampled users as inputs and the labels of the plurality of sampled users as supervisory outputs.

In some embodiments, the historical data may include first data and second data. The first data may relate to user activities initiated by the sampled users within a first time window. The second data may relate to user activities initiated by the sampled users within a second time window after the first time window. The plurality of first feature parameters may be determined based on the first data, and the at least one second feature parameter may be determined based on the second data.

In some embodiments, the method may further include assigning the label to the user based further on one or more of the plurality of first feature parameters.

In some embodiments, the prediction model may include one or more decision trees.

According yet to another aspect of the present disclosure, a system for preventing user churn in an online-to-offline service platform is provided. The system may include at least one network interface to communicate with a plurality of mobile computing devices via a network, one or more storage devices implementing at least one database, and at least one processor in communication with the at least one network interface. The at least one processor may be configured to retrieve historical data associated with a first plurality of users. The historical data may relate to user activities initiated by the first plurality of users during a predetermined time period. The at least one processor may be configured further to, for each user of the first plurality of users, determine a first feature vector of the user based on the historical data associated with the user, and determine a churn probability of the user by inputting the first feature vector of the user into a prediction model. The at least one processor may be configured further to, for each user of the first plurality of users, assign, based on the determined churn probability of the user, the user to one of a plurality of predetermined groups, each of which is associated with a user retention strategy. The at least one processor may be configured further to, for each user of the first plurality of users, determine a user retention operation for the user based on the user retention strategy associated with the predetermined group that the user is assigned to, and perform the user retention operation on the user. The user retention operation may include providing one or more promotions to use the online-to-offline service via a user interface of an online-to-offline service application implemented in a terminal device of the user.

According yet to another aspect of the present disclosure, a non-transitory computer readable medium storing instructions is provided. The instruction, when executed by a processor, may cause the processor to execute operations. The operations may include retrieving historical data associated with a first plurality of users, wherein the historical data relates to user activities initiated by the first plurality of users during a predetermined time period. The operations may also include, for each user of the first plurality of users, determining a first feature vector of the user based on the historical data associated with the user, and determining a churn probability of the user by inputting the first feature vector of the user into a prediction model. The operations may further include, for each user of the first plurality of users, assigning, based on the determined churn probability of the user, the user to one of a plurality of predetermined groups, each of which is associated with a user retention strategy. The operations may also include determining a user retention operation for the user based on the user retention strategy associated with the predetermined group that the user is assigned to, and performing the user retention operation on the user. The user retention operation may include providing one or more promotions to use the online-to-offline service via a user interface of an online-to-offline service application implemented in a terminal device of the user.

Additional features will be set forth in part in the description which follows, and in part will become apparent to those skilled in the art upon examination of the following and the accompanying drawings or may be learned by production or operation of the examples. The features of the present disclosure may be realized and attained by practice or use of various aspects of the methodologies, instrumentalities and combinations set forth in the detailed examples discussed below.

### BRIEF DESCRIPTIONS OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is a schematic diagram illustrating a process for preventing user churn according to some embodiments of the present disclosure;

FIG. 2 is a schematic diagram illustrating an exemplary processor for executing a user retention strategy according to some embodiments of the present disclosure;

FIG. 3 is a schematic diagram illustrating an exemplary process for detecting the accuracy of the prediction model according to some embodiments of the present disclosure;

FIG. 4 is a schematic diagram illustrating an exemplary process for labeling the sampled users according to some embodiments of the present disclosure;

FIG. 5 is a schematic diagram illustrating an exemplary user churn preventing device according to some embodiments of the present disclosure;

FIG. 6 is a schematic diagram illustrating an exemplary execution module according to some embodiments of the present disclosure;

FIG. 7 is a schematic diagram illustrating an exemplary computing device;

FIG. 8 is a schematic diagram illustrating an exemplary process for preventing user churn according to some embodiments of the present disclosure;

FIG. 9 is a schematic diagram illustrating an exemplary process for updating a user retention strategy associated with a group according to some embodiments of the present disclosure;

FIG. 10 is a schematic diagram illustrating an exemplary user churn preventing device according to some embodiments of the present disclosure;

FIG. 11 is a schematic diagram illustrating an exemplary online-to-offline service system according to some embodiments of the present disclosure; and

FIGS. 12 and 13 are schematic diagram illustrating an exemplary presentation including information for reducing the churn risk of a user according to some embodiments of the present disclosure.

### DETAILED DESCRIPTION

Embodiments of the present disclosure provide methods and systems for preventing user churn. A machine learning model is adopted for determining churn probabilities of a plurality of users associated with an online-to-offline service platform. The one or more users may be classified, based on the determined churn probability, into a plurality of groups (e.g., a “churned” group and a “non-churned” group), each of which is associated with a different user retention strategy. Different user retention strategies may be adopted for users of different groups. In some embodiments, the user retention strategies associated with one or more of the plurality of groups may be updated based on their effects on retaining users of the corresponding groups.

The following description is presented to enable any person skilled in the art to make and use the present disclosure, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown, but is to be accorded the widest scope consistent with the claims.

The flowcharts used in the present disclosure illustrate operations that systems implement according to some embodiments of the present disclosure. It is to be expressly understood, the operations of the flowcharts may be implemented not in order. Conversely, the operations may be implemented in inverted order, or simultaneously. Moreover, one or more other operations may be added to the flowcharts. One or more operations may be removed from the flowcharts.

Moreover, while the systems and methods disclosed in the present disclosure are described primarily regarding online-to-offline transportation service, it should also be understood that this is only one exemplary embodiment. The system or method of the present disclosure may be applied to any other kind of online-to-offline service. For example, the system or method of the present disclosure may be applied to different transportation systems including land, ocean, aerospace, or the like, or any combination thereof. The vehicle of the transportation systems may include a taxi, a private car, a hitch, a bus, a vessel, an aircraft, a driverless vehicle, a bicycle, a tricycle, a motorcycle, or the like, or any combination thereof. The transportation system may also include any transportation system that applies management and/or distribution, for example, a system for transmitting and/or receiving an express, or a system for a take-out service. The application scenarios of the system or method of the present disclosure may include a web page, a plug-in of a browser, a client terminal, a custom system, an internal analysis system, an artificial intelligence robot, or the like, or any combination thereof.

The terms “passenger,” “requester,” “service requester,” and “customer” in the present disclosure are used interchangeably to refer to an individual, an entity or a tool that may request or order a service. Also, the terms “driver,” “provider,” “service provider,” and “supplier” in the present disclosure are used interchangeably to refer to an individual, an entity, or a tool that may provide a service or facilitate the providing of the service. The term “user” in the present disclosure may refer to an individual, an entity, or a tool that may request a service, order a service, provide a service, or facilitate the providing of the service. For example, the user may be a passenger, a driver, an operator, or the like, or any combination thereof. In the present disclosure, terms “passenger” and “passenger terminal” may be used interchangeably, and terms “driver” and “driver terminal” may be used interchangeably.

The term “service request” in the present disclosure refers to a request that initiated by a passenger, a requester, a service requester, a customer, a driver, a provider, a service provider, a supplier, or the like, or any combination thereof. The service request may be accepted by any one of a passenger, a requester, a service requester, a customer, a driver, a provider, a service provider, or a supplier. The service request may be chargeable, or free.

The positioning technology used in the present disclosure may include a global positioning system (GPS), a global navigation satellite system (GLONASS), a compass navigation system (COMPASS), a Galileo positioning system, a quasi-zenith satellite system (QZSS), a wireless fidelity (WiFi) positioning technology, or the like, or any combination thereof. One or more of the above positioning technologies may be used interchangeably in the present disclosure.

An aspect of the present disclosure relates to systems and methods for displaying information relating to an online-to-offline service (e.g., a taxi service). In order to help a passenger who initiates a service request of the taxi service to identify a vehicle of a driver who accepts the service request easily and quickly, an online-to-offline service platform may generate an image showing a type of the vehicle of the driver, a color of the vehicle of the driver, a plate number of the vehicle of the driver, and/or a mark on a surface of the vehicle of the driver, and showing the vehicle of the driver from a perspective of the passenger. Alternatively or additionally, the online-to-offline service platform may generate a map showing a real-time position of the vehicle of the driver and real-time positions of other vehicles surrounding the vehicle of the driver. In order to help the passenger to monitor the process of the online-to-offline service without unlocking the passenger's smart phone when the passenger's smart phone is locked, the online online-to-offline service platform may determine information corresponding to the process of the on-demand service, and send the information corresponding to the process of the on-demand service along with a display instruction to the passenger's smart phone. The display instruction may prompt the passenger's smart phone to display the information corresponding to the process of the online-to-offline service on a lock screen interface of the passenger's smart phone when the passenger's smart phone is locked.

It should be noted that online-to-offline service transportation service, such as online taxi service, is a new form of service rooted only in post-Internet era. It provides technical solutions to users and service providers that could raise only in post-Internet era. In the pre-Internet era, when a user hails a taxi on the street, the taxi request and acceptance occur only between the passenger and one taxi driver that sees the passenger. If the passenger hails a taxi through a telephone call, the service request and acceptance may occur only between the passenger and one service provider (e.g., one taxi company or agent). Online taxi service, however, obtains transaction requests in real-time and automatically. The online taxi service also allows a user of the service to real-time and automatic distribute a service request to a vast number of individual service providers (e.g., taxi) distance away from the user and allows a plurality of service providers to respond to the service request simultaneously and in real-time. Therefore, through Internet, the online-to-offline transportation systems may provide a much more efficient transaction platform for the users and the service providers that may never met in a traditional pre-Internet transportation service system.

In the following detailed description, numerous specific details are set forth by way of examples in order to provide a thorough understanding of the relevant disclosure. However, it should be apparent to those skilled in the art that the present disclosure may be practiced without such details. In other instances, well known methods, procedures, systems, components, and/or circuitry have been described at a relatively high-level, without detail, in order to avoid unnecessarily obscuring aspects of the present disclosure. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown, but to be accorded the widest scope consistent with the claims.

The terminology used herein is for the purpose of describing particular example embodiments only and is not intended to be limiting. As used herein, the singular forms “a”, “an”, and “the” may be intended to include the plural forms as well, unless the context clearly indicates otherwise. It will be further understood that the terms “comprise”, “comprises”, and/or “comprising”, “include”, “includes”, and/or “including”, when used in this specification, specify the presence of stated features, integers, steps, operations, elements, and/or components, but do not preclude the presence or addition of one or more other features, integers, steps, operations, elements, components, and/or groups thereof.

It will be understood that the term “system,” “unit,” “module,” and/or “block” used herein are one method to distinguish different components, elements, parts, section or assembly of different level in ascending order. However, the terms may be displaced by another expression if they achieve the same purpose.

Generally, the word “module,” “sub-module,” “unit,” or “block,” as used herein, refers to logic embodied in hardware or firmware, or to a collection of software instructions. A module, a unit, or a block described herein may be implemented as software and/or hardware and may be stored in any type of non-transitory computer-readable medium or another storage device. In some embodiments, a software module/unit/block may be compiled and linked into an executable program. It will be appreciated that software modules can be callable from other modules/units/blocks or from themselves, and/or may be invoked in response to detected events or interrupts.

Software modules/units/blocks configured for execution on computing devices (e.g., processor 704 as illustrated in FIG. 7) may be provided on a computer-readable medium, such as a compact disc, a digital video disc, a flash drive, a magnetic disc, or any other tangible medium, or as a digital download (and can be originally stored in a compressed or installable format that needs installation, decompression, or decryption prior to execution). Such software code may be stored, partially or fully, on a storage device of the executing computing device, for execution by the computing device. Software instructions may be embedded in a firmware, such as an EPROM. It will be further appreciated that hardware modules/units/blocks may be included in connected logic components, such as gates and flip-flops, and/or can be included of programmable units, such as programmable gate arrays or processors. The modules/units/blocks or computing device functionality described herein may be implemented as software modules/units/blocks, but may be represented in hardware or firmware. In general, the modules/units/blocks described herein refer to logical modules/units/blocks that may be combined with other modules/units/blocks or divided into sub-modules/sub-units/sub-blocks despite their physical organization or storage. The description may be applicable to a system, an engine, or a portion thereof.

It will be understood that when a unit, engine, module or block is referred to as being “on,” “connected to,” or “coupled to,” another unit, engine, module, or block, it may be directly on, connected or coupled to, or communicate with the other unit, engine, module, or block, or an intervening unit, engine, module, or block may be present, unless the context clearly indicates otherwise. As used herein, the term “and/or” includes any and all combinations of one or more of the associated listed items.

These and other features, and characteristics of the present disclosure, as well as the methods of operation and functions of the related elements of structure and the combination of parts and economies of manufacture, may become more apparent upon consideration of the following description with reference to the accompanying drawings, all of which form a part of this disclosure. It is to be expressly understood, however, that the drawings are for the purpose of illustration and description only and are not intended to limit the scope of the present disclosure.

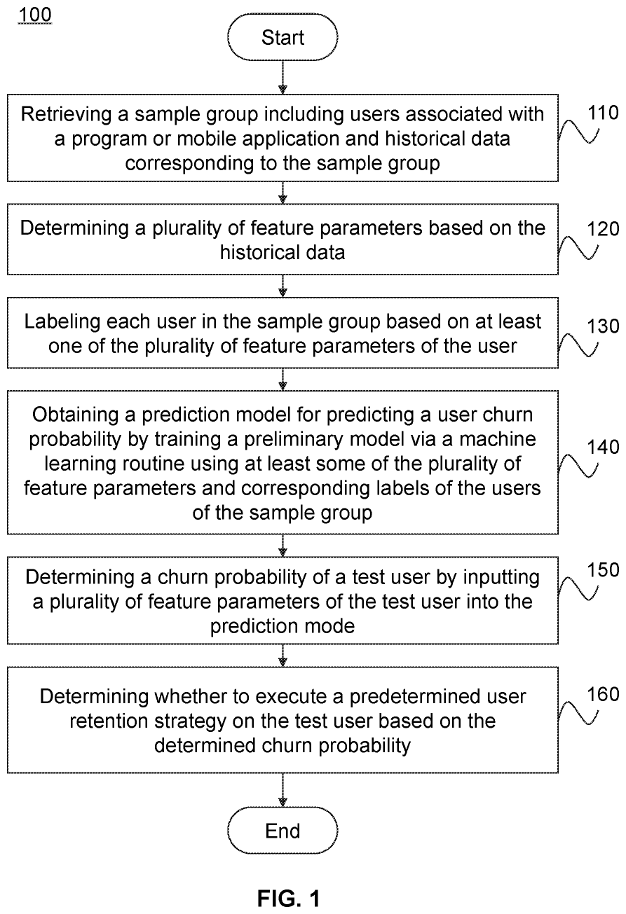

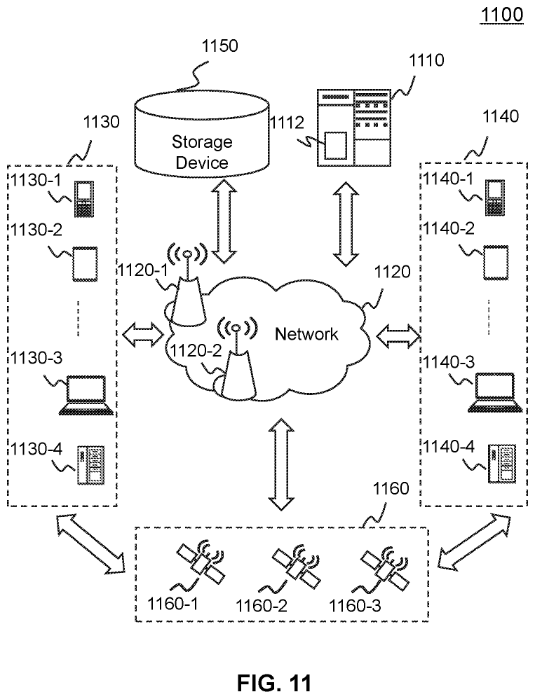

FIG. 1 is a schematic diagram illustrating a process for preventing user churn according to some embodiments of the present disclosure. In some embodiments, process 100 illustrated in FIG. 1 may be implemented in the online-to-offline system 1100 illustrated in FIG. 11 (e.g., by a server 1110 as illustrated in FIG. 11). For example, the process 100 illustrated in FIG. 1 may be stored in a storage device (e.g., storage device 702, storage device 1150) in the form of instructions, and invoked and/or executed by at least one processor (e.g., processor 702 of the computing device 700 as illustrated in FIG. 7).

As shown in FIG. 1, process 100 may include operations 110-160. Operations 111 to 140 may be performed to obtain or train a prediction model for predicting a probability of churn (or be referred to as a churn probability) of a user, and operations 150 and 160 may be performed to predict a churn probability of a user via the prediction model, and to perform, based on the churn probability, a corresponding user retention operation on the user.

In 110, the at least one processor may retrieve a sample group including users (or be referred to as sampled users) associated with a program or a mobile application and historical data corresponding to the sample group.

The historical data may serve as a training dataset of the prediction model and may relate to user activities associated with the program or mobile application of the sampled users. For example, the historical data may include collected user activities and a timestamp associated with each of the user activities. In some embodiments, the program or mobile application may be associated with an online-to-offline service platform. The online-to-offline service platform may provide transportation services (e.g., taxi hailing, chauffeur services, delivery service, carpool, bus service, take-out service, driver hiring and shuttle services), room services, shopping services, financial services, home services, and/or any other service to its users. The user activities associated with the mobile application or the online-to-offline service platform may be collected or obtained by one or more servers of the online-to-offline platform to generate the historical data.

In some embodiments, the user activities may include service requesting activities of the sampled users. The service requesting activities may include sending an order, reserving a service, accepting an offer, browsing services or service providers, cancelling a service, rescheduling a service, using a coupon or voucher, or the like, or a combination thereof.

In some embodiments, the user activities may include application usage activities of the sampled users. The mobile application usage activities may include launching the application, triggering an operation of the application, connecting to a server of an online-to-offline service platform, or the like, or a combination thereof.

In some embodiments, the historical data may also include a location descriptor (e.g., GPS coordinates, road name, street name, city name) associated with each of the user activities. The location descriptor may indicate the location where the corresponding user activity is initiated.

In some embodiments, the at least one processor may obtain the historical data from a dataset. The historical data may include 70% (or any other proper ratio) items (e.g., keys) or data of the dataset. The at least one processor may randomly select data or items from the dataset to form the historical data. The other 30% (or any other proper ratio) items or data of the dataset may be used for testing the performance of the trained prediction model. The dataset may belong to a superior database (e.g., implemented by the storage device 1150). For example, the superior database may include data associated with user activities for all-time, and the sub-database may include data associated with user activities for a predetermined time period. As another example, the superior database may include data associated with all the districts the platform covers, and the sub-database may include data associated with one or more specific districts.

In 120, the at least one processor may determine a plurality of feature parameters based on the historical data.

The at least one processor may extract features from the historical data to determine the plurality of feature parameters. The features extracted by the at least one processor may include features related to user activities (e.g., service requesting activities and/or application usage activities) of a user. Some exemplary features are provided as following: a count of user activities, a frequency of user activities within a certain time interval (e.g., full time (with respect to the time range of the user activities included in the data from which the feature is extracted), one or more working days, one or more weekends, rush hours, working hours, after hours), a distribution (or histogram) of user activities with respect to a certain time interval, a duration of the user activity, a time point when the latest user activity is performed, etc.

In some embodiments, the features extracted by the at least one processor may further include features reflecting the user preference on the user activities. Some exemplary features are provided as following: a location or locations (e.g., GPS coordinates range, the street, the city) where most of the activities are performed, a time range when most of the activities are performed, types of the most activities, etc.

A feature may be associated with a single type of user activities or multiple types of user activities. A feature associated with a single type of user activities may be like, for example, a count (or frequency, histogram) of order sending activities within a given time (e.g., the latest week, the full time), a latest time point when the application connects to a server of the platform, etc. A feature associated with multiple types of users activities may be like, for example, a count (or frequency, histogram) of order sending activities and offer accepting activities when using a coupon within a given time, a count of order sending activities with no subsequent cancellation of the service, etc.

In some embodiments, as different types of users may have different behavior patterns, the features extracted by the at least one processor may further include features related to the user or a usage state of the user. Some exemplary features are provided as following: the gender of the user, the age of the user, the hometown of the user, the education background of the user, the job of the user, the time length since the registration of the user, etc.

It may be noted that, the above features are only provided for demonstration purposes and not intended to be limiting.

The at least one processor may determine a plurality of feature parameters for each user of the sample group by extracting corresponding features from the historical data associated with the user. The determined feature parameters of a user may include a plurality of first feature parameters and at least one second feature parameter. The plurality of first feature parameters of a user may form a feature vector of the user, which may serve as an input of the prediction model. The at least one second feature parameter of a user may be used to label the user.

In some embodiments, the historical data associated with the user may include first data and second data. The first data may relate to user activities within a first time window and the second data may relate to user activities within a second time window after the first time window. For example, the first time window may be a first predetermined time period ending at a reference time, and the second time window may be a second predetermined time period starting at the reference time. The at least one processor may obtain the plurality of first feature parameters by extracting corresponding first features from the first data and obtain the at least one second feature parameter by extracting corresponding second feature(s) from the second data.

In some embodiments, the second feature(s) may be included in the first features. For example, a second feature may be a count of order sending activities of the full time (with respect to the second time window), and the first features may also include a feature that is a count of order sending activities of the full time (with respect to the first time window).

In some embodiments, the first predetermined time period may be longer than or equal to the second time interval.

In 130, the at least one processor may label each user in the sample group based on at least one of the plurality of feature parameters of the user.

To label a user, the at least one processor may assign a label to the user based on at least one of the plurality of feature parameters of the user. The label may indicate a group that the user belongs to.

The at least one processor may label a user as belonging to a group of a first plurality of predetermined groups. In some embodiments, the first plurality of predetermined groups may only include two predetermined groups, such as a group representing churned users (or be referred to as a “churned” group) and a group representing the non-churned users (or be referred to as a “non-churned” group). The at least one processor may label a user as belonging to the “churned” group or the “non-churned” group. In the present disclosure, a user labeled as belonging to the “churned” group may also be referred to as a negative sample, while a user labeled as belonging to the “non-churned” group may be referred to as a positive sample.

In some embodiments, the first plurality of predetermined groups may include more than two predetermined groups, such as a group representing churned users and/or users having a high churn risk (or be referred to as the “high-risk” group), a group B representing users having a moderate churn risk (or be referred to as the “moderate-risk” group), and a group representing users having a low churn risk (or be referred to as the “low-risk” group).

In some embodiments, the at least one processor may label a user by comparing the value of the at least one second feature parameter with a single labeling threshold or a set of labeling thresholds. The labeling threshold(s) may be predetermined or dynamically determined (e.g., based on a mean, a median, a mode, or a rank of the second feature parameters of all the users). A single labeling threshold may be used to label the users into two groups (e.g., the “churned” group and the “non-churned” group). A set of labeling thresholds may be used to label the users into more than two groups (e.g., the “high-risk” group, the “moderate-risk” group, and the “low-risk” group).

In some embodiments, the at least one processor may label a user based further on one or more of the plurality of first feature parameters. For example, the at least one processor may label a user based on the at least one second feature parameter in the condition that a first feature parameter (e.g., the one representing a count of service requesting the user performed in the first time window) of the user is above a predetermined threshold.

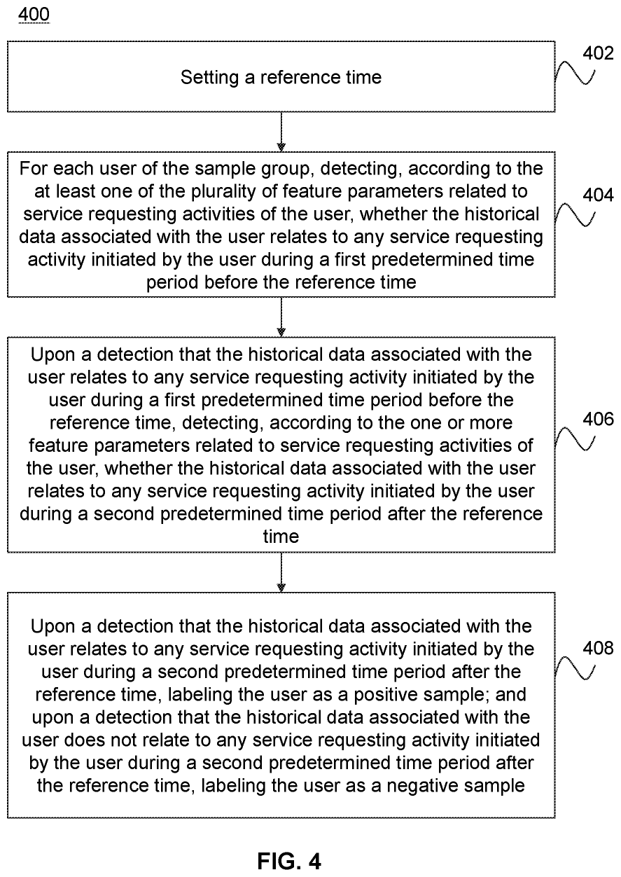

An exemplary labelling process is described in connection with FIG. 4, which is only for demonstration purposes and not intended to be limiting.

In 140, the at least one processor may obtain a prediction model for predicting a user churn probability by training a preliminary prediction model via a machine learning routine using at least some of the plurality of feature parameters and the labeled users of the sample group.

The preliminary prediction model may be generated with a set of initial parameters, which are iteratively optimized during the training until the preliminary prediction model converges. The trained preliminary prediction model is then used for predicting the user churn probability. For simplicity, the training of the preliminary prediction model may also be referred to as the “training of the prediction model” in the present disclosure.

Via operation 120, the at least one processor may obtain a plurality of first feature parameters for each user of the sample group. The plurality of first feature parameters may form a feature vector of the user, which may serve as an input of the prediction model. The label assigned to the user in the operation 130 may serve as a corresponding supervisory output.

The machine learning algorithm adopted in the machine learning routine for training the prediction model may include a decision tree based algorithm (e.g., a gradient boosting decision tree (GBDT) algorithm, a random forest algorithm, a classification and regression tree (CART) algorithm, an ID3 algorithm, a C4.5 algorithm), a logistic regression algorithm, a neural network algorithm, a naive Bayers algorithm, a k-means algorithm, a principle component analysis (PCA) algorithm, or the like, or a combination thereof. Different machine learning algorithm may be adopted in different embodiments of the present disclosure.

After the training, the prediction model may be used to determine whether a test user is to be a churned user. The test user may be further classified into different groups. The prediction model may determine a churn probability of the test user, and the classification may be based on the determined churn probability.

In 150, the at least one processor may determine a churn probability of a test user by inputting a plurality of feature parameters of the test user into the prediction model.

The at least one processor may determine the plurality of feature parameters of the test user by extracting the first features from historical data associated with the test user (or be referred to as test historical data). The determined feature parameters may form a feature vector of the test user. For the convenience of description, a feature vector of a test user for determining the churn probability via the prediction model may be referred to as a first feature vector, and a feature vector of a sampled user for training the prediction model may be referred to as a second feature vector. The first feature vector and the second feature vector may correspond to a same set of features (first features).

The test historical data may relate to user activities of the test user within a third time window. The third time window may have a time length equal to the first time window. The third time window may end at the current time point (the time point when the operation 150 is performed) or a time point before the current time point (e.g., the end of the last hour, day, week, month, quarter, or year).

In 160, the at least one processor may determine whether to execute a predetermined user retention strategy on the test user based on the determined churn probability.

A user retention strategy may include or be associated with one or more user retention operations. For example, a user retention strategy may be in the form of a list or a look-up table including one or more user retention operations associated with the user retention strategy. To execute a user retention strategy on the test user, the at least one processor may determine a user retention operation based on the list or the look-up table implementing the user retention strategy, for example, by retrieving or selecting a user retention operation from the list or the look-up table. The retrieving or selecting may be performed randomly or based on the churn probability of the test user.

It may be noted that, a user retention strategy may take any other proper form. For example, a user retention strategy may be in the form of one or more models or functions. The one or more models or functions may take the churn probability as at least a part of its input and may output one or more parameters related to a user retention operation to be performed. The one or more parameters may include an identification number (e.g., a serial number) of a user retention operation, a parameter representing an extent of the user retention operation (e.g., a discount), a parameter representing a frequency for performing the user retention operation (e.g., a frequency for promotions), or the like, or a combination thereof. To execute a user retention strategy on the test user, the at least one processor may determine a user retention operation to be performed based the one or more parameters.

In 160, the at least one processor may classify the test user into a “churned” group or a “non-churned” group, the “churned” group may associate with a predetermined user retention strategy and the “non-churned” group may not associate with a user retention strategy. The at least one processor may execute the predetermined user retention strategy associated with the “churned” group to a test user classified (or identified) as a “churned” user, and may pass a test user classified (or identified) as a “non-churned” user.

In some embodiments, the “non-churned” group may also associate with a user retention strategy (different from the one associated with the “churned” group). For example, the user retention strategy associated with the “churned” group may take more efforts on retaining a user (e.g., offering a higher discount or offering discounts in a higher frequency) and the user retention strategy associated with the “non-churned” group may take fewer efforts on retaining a user (e.g., offering a lower discount or offering discounts in a lower frequency).

It may be noted that, the aforementioned “pass” operation or any other similar conditional non-act operation (e.g., “keep monitoring”, “skip”) may also be considered as a user retention strategy or user retention operation in the present disclosure. The at least one processor may adopt different user retention strategies on users of different groups.

The predetermined groups for classifying the test user(s) may be referred to as a second plurality of predetermined groups. The at least one processor may classify (or identify) a test user into a group of the second plurality of predetermined groups based on the churn probability of the test user determined in the operation 150, and then determine a user retention operation to be performed for the test user based on the user retention strategy associated with the group of the test user.

The second plurality of predetermined groups may correspond to the first plurality of predetermined groups in operation 130. For example, in operation 130, the at least one processor may label the sampled users as belonging to a “churned” group or a “non-churned” group; and in operation 160, the at least one processor may also identify the test user as belonging to a “churned” group (representing users identified as to be churned) or a “non-churned” group (representing users identified as not to be churned).

Alternatively, the second plurality of predetermined groups may be different from the first plurality of predetermined groups in operation 130. For example, in operation 130, the at least one processor may label the sampled users as belonging to a “churned” group or a “non-churned” group; and in operation 160, the at least one processor may identify, based on the determined churn probability, the test user as belonging to a “high-risk” group (representing users identified as having a high risk to be churned), a “moderate-risk” group (representing users identified as having a moderate risk to be churned), or a “low-risk” group (representing users identified as having a low risk to be churned).

The at least one processor may classify (or identify) the test user by comparing the churn probability of the test user with a single probability threshold or a set of probability thresholds. The probability threshold(s) may be predetermined or dynamically determined (e.g., based on a mean, a mode, a median, or a rank of the determined churn probability of all the users). A single probability threshold (e.g., 50%) may be used when the plurality of predetermined two groups includes only two groups (e.g., a “churned” group (e.g., <50%) and a “non-churned” group (e.g., >50%)). A set of probability thresholds (e.g., 30% and 70%) may be used when the second plurality of predetermined groups includes more than two groups (e.g., a “high-risk” group (e.g., >70%), a “moderate-risk” group (e.g., within the range [30%, 70%)), and a “low-risk” group (e.g., <30%)).

In the present disclosure, test users classified into the “churned” group and the “non-churned” group may also be referred to as a “churned” user and a “non-churned” user, respectively. Similarly, test users classified into the “high-risk” group, the “moderate-risk” group, and the “low-risk” group may be referred to a “high-risk” user, a “moderate-risk” user, and a “low-risk” user, respectively.

Each of the second plurality of predetermined groups may be associated with a user retention strategy. For a user (e.g., the test user) identified as belonging to a certain group, the at least one processor may determine, based on the user retention strategy associated with that group, a user retention operation to be performed on the user. The user retention operation may be intended to reduce or maintain the churn risk of the user. For example, the user retention operation may include providing one or more promotions to use the online-to-offline service via a user interface of an online-to-offline service application implemented in a terminal device of the user.

In some embodiments, a user retention operation to be performed on a churned user may include sending information (e.g., in the form of an email, a text message, a notification, a telephone call) to the user to provide a sales promotion, to offer a discount, to inform a coming marketing activity, etc. As another example, a user retention operation may include no actions or no obvious actions (such as “keep monitoring”).

Different groups may be associated with different predetermined user retention strategies. For example, a group representing users having a higher churn risk (e.g., the “churned” group, the “high-risk” group) may be associated with a user retention strategy taking more efforts on user retention (e.g., offering a larger discount, providing sales promotions more frequently, informing marketing activities in a higher frequency, providing premium service providers); a group representing users having a lower churn risk (e.g., the “non-churned” group, the “low-risk” group) may be associated with a user retention strategy taking fewer efforts on user retention (e.g., offering a smaller discount, providing sales promotions less frequently, informing marketing activities in a lower frequency, performing no action).

In some embodiments, during a user retention operation, the at least one processor may provide data to be executed by a mobile computing device (e.g., a mobile phone) of the corresponding user. The data may cause the mobile computing device or an online-to-offline service application implemented in the mobile computing device to generate a presentation (e.g., a notification) on the display of the mobile computing device, and the presentation may include the information to be provided to the user for reducing the user's churn probability. For example, the information may include contents providing a promotion, offering a discount, or informing a coming marketing activity.

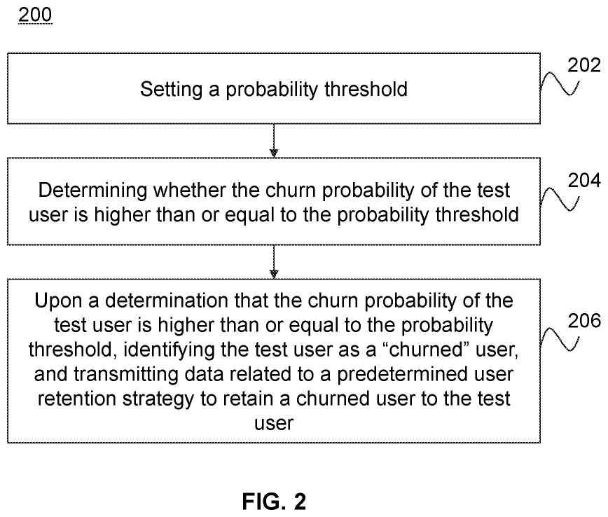

In some embodiments, the at least one processor may perform the operation 160 in a process as illustrated in FIG. 2.

In some embodiments, via the process 100, a prediction model capable of accurately predicting probability of user churn may be obtained by training the prediction model with historical data of a sample group including users associated with a program or a mobile application via a machine learning routine. During the training, for each user of the sample group, the at least one processor may obtain a plurality of feature parameters of the user by extracting features from the historical data associated with the user, and label the user based on at least one of the feature parameters. For example, the at least one processor may label a user of the sample group as a positive sample or a negative sample. When all the users of the sampled group are labeled, the at least one processor may train the model using some of the feature parameters and the labels of the sampled users, so as to obtain the prediction model. Subsequently, the at least one processor may use the prediction model to predict a churn probability of a test user, and determine whether the test user will churn (i.e., to determine whether the test user belongs to a “churned” group or a “non-churned” group) based on the predicted churn probability. The at least one processor may further determine whether to inform a marketing activity and/or to retain the test user to prevent user churn.

In some embodiments, the machine learning algorithm adopted in the machine learning routine for obtaining the prediction model may include a GBDT algorithm, a logistic regression algorithm, etc. The training may be performed off-line. With the adopted machine learning algorithm, the at least one feature parameters obtained from the historical data, and the labeled users of the sample group, the model may be trained and optimized iteratively, so as to obtain a qualified prediction model for predicting user churn probability.

In some embodiments, the prediction model may directly output the group assigned to the test user without outputting the churn probability of the test user. The at least one processor may then execute the user retention strategy corresponding to the outputted group on the test user.

In some embodiments, the at least one processor may periodically perform one or more operations of the process 100. For example, the at least one processor may perform the operations 110 to 140 with a first period to periodically update the prediction model. As another example, the at least one processor may perform the operation 150 and 160 with a second period to periodically prevent user churn. The first period may be equal to the second period or not.

In some embodiments, the first features extracted by the at least one processor for labeling a sampled user or identifying (or classifying) a test user may further include features related to the user retention operation(s) performed on the user or the group(s) assigned to the user in previous user retention cycle(s).

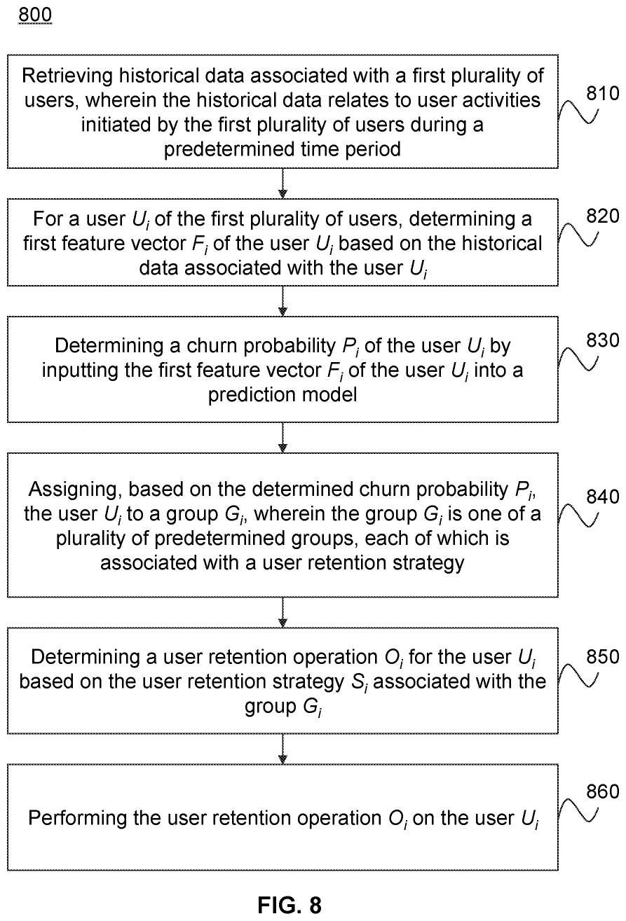

In some embodiments, the at least one processor may repeat operations 150 and 160 to prevent a churn of a plurality of users. An exemplary process is described in connection with FIG. 8.

It may be noted that the above descriptions of the process for preventing user churn are only for demonstration purposes and not intended to be limiting. It is to be understood that, after learning the major concept and the mechanism of the present disclosure, a person of ordinary skill in the art may alter the process 100 in an uncreative manner. For example, one or more optional operations may be added to or removed from process 100. One or more operations may be divided or be combined. All such modifications are within the protection scope of the present disclosure.

FIG. 2 is a schematic diagram illustrating an exemplary processor for executing a user retention strategy according to some embodiments of the present disclosure. In some embodiments, process 200 may be performed to achieve the operation 160 of the process 100 as illustrated in FIG. 1. In some embodiments, the process 200 illustrated in FIG. 2 may be implemented in the online-to-offline system 1100 illustrated in FIG. 11 (e.g., by a server 1110 as illustrated in FIG. 11). For example, the process 200 illustrated in FIG. 2 may be stored in a storage device (e.g., storage device 702, storage device 1150) in the form of instructions, and invoked and/or executed by at least one processor (e.g., processor 702 of the computing device 700 as illustrated in FIG. 7).

In 202, the at least one processor may determine or set a probability threshold.

It is understood that, a selection or determination of the probability threshold may affect the identification of “churned” users (or “high-risk” users). By setting a higher probability threshold, the accuracy of the identification may be increased, but the amount of identified “churned” users may be reduced. Therefore, the probability threshold may be set or determined according to the actual implementation scenario.

In 204, the at least one processor may determine whether the churn probability of the test user is higher than or equal to the probability threshold.

In 206, upon a determination that the churn probability of the test user is higher than or equal to the probability threshold, the at least one processor may identify the test user as a “churned” user (be classified into the “churned” group), and may transmit (e.g., push) data related to a predetermined user retention strategy to retain a churned user (i.e., the user retention strategy associated with the “churned” group) to the test user.

In some embodiments, the at least one processor may set the probability threshold with a proper value to ensure the accuracy of the determination that whether a test user is to be a churned user based on the churn probability of the user outputted by the prediction model. When the churn probability obtained by inputting the feature parameters of the test user into the prediction model is higher than or equal to the probability threshold, the at least one processor may identify the test user as a “churned” user. The higher the churn probability, the higher the chance of the user to churn in future. Further, to prevent user churn, the at least one processor may transmit data or information related to the predetermined user retention strategy associated with the “churned” group to the test user. For example, the at least one processor may transmit vouchers, coupons, latest discounts to the determined “churned” user, in order to implement the default drain. When executing the user retention strategy, the at least one processor may transmit the corresponding data or information to the “churned” user periodically within a predetermined time period. The setting of the probability threshold may be based on actual needs.

In some embodiments, when the churn probability outputted by the prediction model is lower than the probability threshold, the at least one processor may identify the test user as a “non-churned” user. The at least one processor may skip transmitting data to the “non-churned” user temporarily (e.g., for a week, a month, or before a next prediction of user churn).

It may be noted that, the process 200 may also be altered for classifying users into more than two groups. For example, when the second preliminary of predetermined groups includes a “high-risk” group, a “moderate-risk” group, and a “low-risk” group, the at least one processor may determine a first probability threshold and a second probability threshold. The first probability threshold may be higher than the second probability threshold. When the determined churn probability is higher than the first probability threshold, the at least one processor may classify the test user into the “high-risk” group. When the determined churn probability is between the first probability threshold and the second probability threshold, the at least one processor may classify the test user into the “moderate-risk” group. When the determined churn probability is lower than the second probability threshold, the at least one processor may classify the test user into the “low-risk” group. The at least one processor may transmit data corresponding to a first predetermined user retention strategy associated with the “high-risk” group to a “high-risk” user. The at least one processor may also transmit data corresponding to a second predetermined user retention strategy associated with the “moderate-risk” group to a “moderate-risk” user. The first predetermined user retention strategy may take more efforts on retaining the user. The at least one processor may skip transmitting data to the “low-risk” user temporarily.

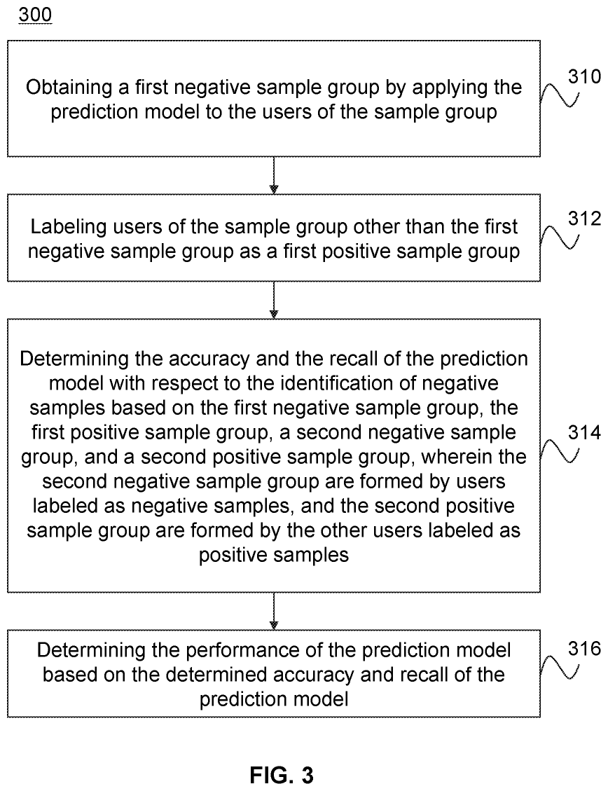

In some embodiments, after the operation 202 and before the operation 204, the process 200 may further include operations illustrated in FIG. 3 to determine the accuracy of the prediction model.

FIG. 3 is a schematic diagram illustrating an exemplary process for detecting the accuracy of the prediction model according to some embodiments of the present disclosure. In some embodiments, process 300 illustrated in FIG. 3 may be implemented in the online-to-offline system 1100 illustrated in FIG. 11 (e.g., by a server 1110 as illustrated in FIG. 11). For example, the process 300 illustrated in FIG. 3 may be stored in a storage device (e.g., storage device 702, storage device 1150) in the form of instructions, and invoked and/or executed by at least one processor (e.g., processor 702 of the computing device 700 as illustrated in FIG. 7).

In 310, the at least one processor may obtain a first negative sample group by applying the prediction model to the users of the sample group.

The first negative sample group is formed by users identified as negative samples (e.g., “churned” users or classified into the “churned” group) based on the corresponding churn probabilities outputted by the prediction model.

In 312, the at least one processor may label users of the sample group other than the first negative sample group as a first positive sample group.

In other words, the first positive sample group is formed by users identified as “non-churned” users based on the corresponding churn probabilities outputted by the prediction model.

In the operation 130, users labeled as negative samples may form a second negative sample group (i.e., the “churned” group), and the other users labeled as positive samples may form a second positive sample group (i.e., the “non-churned” group). Then in 314, the at least one processor may determine the accuracy and the recall of the prediction model with respect to the identification of negative samples (“churned” users) based on the first negative sample group, the first positive sample group, the second negative sample group, and the second positive sample group.

In 316, the at least one processor may determine the performance of the prediction model based on the determined accuracy and recall of the prediction model.

In some embodiments, after setting the probability threshold (operation 202), and before determining whether the test user is a “churned” user, the at least one processor may first detect an accuracy of the prediction model obtained via the iteratively optimization. For each user of the sample group, the at least one processor may input feature parameters (first feature parameters or first feature vector) of the user into the prediction model to obtain a corresponding churn probability of the user, and compare the obtained churn probability with the probability threshold. Accordingly, in the sample group, the at least one processor may determine the first negative sample group and the first positive sample group via the prediction model. Further, the at least one processor may compare the first negative sample group with the second negative sample group formed by negative samples determined in the labeling of the users (the operation 130), and determine a count TN of true negative samples and a count FN of positive samples identified as negative samples (false negative samples). The at least one processor may also compare the first positive sample group with the second positive sample group formed by positive samples determined in the labeling of the users (the operation 130), and determine a count TP of true positive samples and a count FP of negative samples identified as positive samples (false positive samples). The at least one processor may then determine the accuracy (A_{N}) and recall (R_{N}) of the prediction model with respect to the identification of negative samples via the following equations:

R_{N}=TN/(TN+FP), (Equation 1)

A_{N}=(TP+TN)/(TP+FN+FP+TN) (Equation 2)

wherein “/” represents a division operator.

The at least one processor may then determine the performance of the prediction model with respect to the detection of negative samples based on the determined accuracy and recall. There is an inverse correlation between the accuracy and the recall. The higher the recall, the lower the accuracy. According to the actual needs, biased criterion may be selected for detecting the performance of prediction model for identifying negative samples. For example, if there are needs to recall negative samples or identify “churned” users as many as possible, the at least one processor may set the probability threshold with a lower value and properly reduce the accuracy of the prediction model. If there are needs to accurately identify “churned” users, the at least one processor may set the probability threshold with a higher value and properly reduce the recall of the prediction model.

In some embodiments, the at least one processor may determine at least one performance indicator of the prediction model. The at least one performance indicator may include an accuracy, a recall, a precision, a specificity, a miss rate, or the like, or a combination thereof. The at least one processor may adaptively adjust the probability threshold (or a plurality of probability thresholds for classifying the test user into more than two groups), so that the at least one performance indicator may be within a target range for the at least one performance indicator. The target range may be inputted by a user or determined by the at least one processor according to actual needs.

In some embodiments, the feature parameters may relate to service requesting activities (e.g., sending an order, reserving a service, accepting an offer) of a user. For example, the feature parameters related to service requesting activities may include a count of service requesting activities, a frequency of service requesting activities within a certain time interval, the time of the latest service requesting activities, etc., and the user may be labeled according to different aspects.

In some embodiments, the operation 130 illustrated in FIG. 1 may be achieved via a process illustrated in FIG. 4. FIG. 4 is a schematic diagram illustrating an exemplary process for labeling the sampled users according to some embodiments of the present disclosure. In some embodiments, process 400 illustrated in FIG. 4 may be implemented in the online-to-offline system 1100 illustrated in FIG. 11 (e.g., by a server 1110 as illustrated in FIG. 11). For example, the process 400 illustrated in FIG. 4 may be stored in a storage device (e.g., storage device 702, storage device 1150) in the form of instructions, and invoked and/or executed by at least one processor (e.g., processor 702 of the computing device 700 as illustrated in FIG. 7).

In 402, the at least one processor may determine or set a reference time.

In 404, for each user of the sample group, the at least one processor may detect, according to the at least one of the plurality of feature parameters related to service requesting activities (e.g., one or more first feature parameters) of the user, whether the historical data associated with the user relates to any service requesting activity initiated by the user during a first predetermined time period before the reference time (the first time window).

In 406, upon a detection that the historical data associated with the user relates to any service requesting activity occurred during a first predetermined time period before the reference time, the at least one processor may detect, according to the at least one of the plurality of feature parameters related to service requesting activities (e.g., one or more second feature parameters) of the user, whether the historical data associated with the user relates to any service requesting activity initiated by the user during a second predetermined time period after the reference time (the second time window).

In 408, upon a detection that the historical data associated with the user relates to any service requesting activity occurred during a second predetermined time period after the reference time, the at least one processor may label the user as a positive sample (a “non-churned” user); and upon a detection that the historical data associated with the user does not relate to any service requesting activity occurred during a second predetermined time period after the reference time, the at least one processor may label the user as a negative sample (a “churned” user).

In some embodiments, the feature parameters used for labeling the sampled users may relate to service requesting activities of a user. Specifically, when labeling a user based on the corresponding feature parameters, the at least one processor may first set the reference time. The reference time may be set based on the time point when the labeling is performed (or be referred to as a current time point). For example, the reference time may be set at a time point certain days (e.g., more than or equal to the second predetermined time period) before the time point when the labeling is performed. Based on the feature parameters related to service requesting activities, upon a determination that the historical data associated with the user relates to any service requesting activity occurred during a first predetermined time period before the reference time, if it is also determined that the historical data associated with the user relates to any service requesting activity occurred during a second predetermined time period after the reference time, the at least one processor may label the user as a positive sample (i.e., a “non-churned” user); if it is determined that the historical data associated with the user does not relate to any service requesting activity occurred during a second predetermined time period after the reference time, the at least one processor may label the user as a negative sample, i.e., a “churned” user. Preferably, the time length of the second predetermined time period is shorter than the time length of the first predetermined time period. Merely for example, the second predetermined time period may be set to 30 days, and the first predetermined time period may be set to 60 days. In some embodiments, the feature parameters related to service requesting activities may include a count of service requesting activates, a frequency of service requesting activities within a certain time interval, the time of the latest service requesting activities, etc., and the user may be labeled according to different aspects.

In some embodiments, the feature parameters may further include features related to behavior preference of a user, such as a traveling time preference, a route preference, a traveling mode preference (e.g., express, private car, carpool, taxi, bicycle), etc., and the user may be labeled further according to the additional aspects.

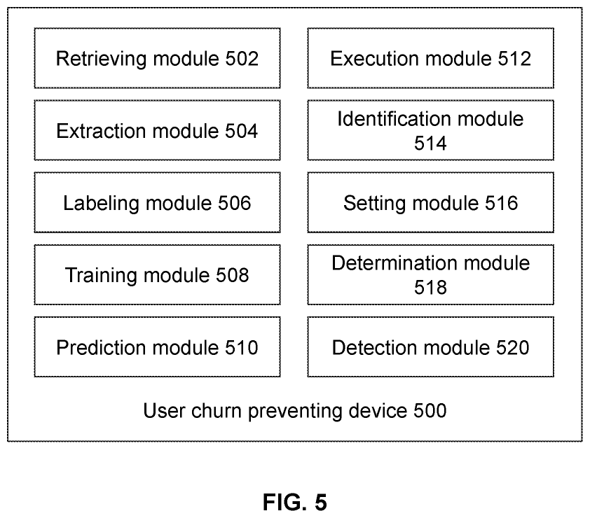

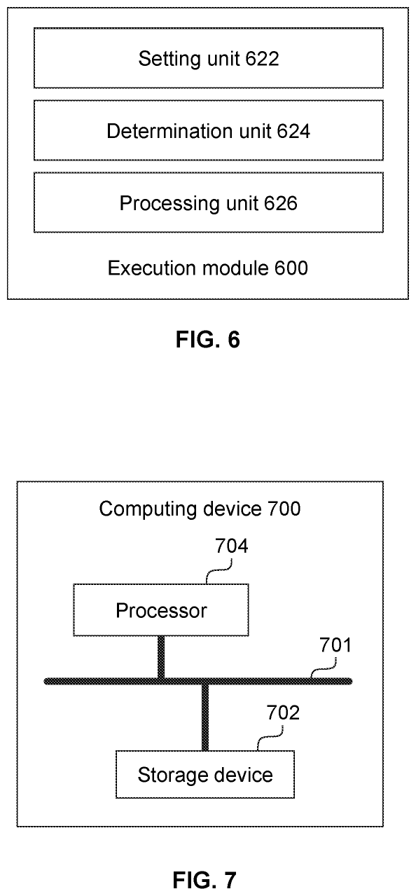

An exemplary user churn preventing device for performing the user churn preventing methods of the present disclosure is described in connection with FIGS. 5 and 6 as following.

FIG. 5 is a schematic diagram illustrating an exemplary user churn preventing device according to some embodiments of the present disclosure. User churn preventing device 500 may include a retrieving module 502, an extraction model 504, a labeling model 506, a training module 508, a prediction module 510, and an execution module 512. In some embodiments, the user churn preventing device 500 or one or more of its modules may be implemented by at least one processor (e.g., the processor 702) to perform the process 100 illustrated in FIG. 1.

The retrieving module 502 may be configured to retrieve a sample group including users associated with a program or a mobile application and historical data corresponding to the sample group.

The extraction model 504 may be configured to determine a plurality of feature parameters based on the historical data.

The labeling model 506 may be configured to label, based on at least one of the plurality of feature parameters, each user in the sample group.

The training module 508 may be configured to obtain a prediction model for predicting a user churn probability by training a preliminary prediction model via a machine learning routine using one or more of the feature parameters and the labeled users of the sample group.

The prediction module 510 may be configured to determine a churn probability of a test user by inputting a plurality of feature parameters of the test user into the prediction mode.

The execution module 512 may be configured to determine, based on the determined churn probability, whether to execute a predetermined user retention strategy on the test user.

Referring to FIG. 6. FIG. 6 is a schematic diagram illustrating an exemplary execution module according to some embodiments of the present disclosure. Execution module 600 may be an example of the execution module 512 illustrated in FIG. 5. The execution module 600 may include a setting unit 622, a determination unit 624 and a processing unit 626.

The setting unit 622 may be configured to set or determine a probability threshold.

The determination unit 624 may be configured to determine whether the churn probability of the test user is higher than or equal to the probability threshold.

The processing unit 626 may be configured to identify, upon a determination that the churn probability of the test user is higher than or equal to the probability threshold, the test user as a “churned” user, and transmit data corresponding to a predetermined user retention strategy to retain a churned user to the test user.

Refer back to FIG. 5. In some embodiments, the user churn preventing device may further include an identification module 514, a setting module 516, a determination module 518, and a detection module 520.

The identification module 514 may be configured to obtain, after the setting unit 622 setting the probability threshold and before the determination unit 624 determining whether the churn probability of the test user is higher than or equal to the probability threshold, a first negative sample group by applying the prediction model to the users of the sample group.

The setting module 516 may be configured to label users of the sample group other than the first negative sample group as a first positive sample group.

The determination module 518 may be configured to determine the accuracy and the recall of the prediction model with respect to the identification of negative samples based on the first negative sample group, the first positive sample group, a second negative sample group, and a second positive sample group. The second negative sample group are formed by users labeled as negative samples in the sample group, and the second positive sample group are formed by the other users labeled as positive samples in the sample group.

The detection module 520 may be configured to determine the performance of the prediction model based on the determined accuracy and recall of the prediction model.

In some embodiments, the feature parameters may relate to service requesting activities. The labeling model 506 may be configured further to determine a reference time; for each of the sampled user, detect, according to at least one of the plurality of feature parameters related to service requesting activities, whether the historical data associated with the user relates to any service requesting activity initiated by the user during a first predetermined time period before the reference time; upon a detection that the historical data associated with the user relates to any service requesting activity occurred during a first predetermined time period before the reference time, detect, according to the at least one of the plurality of feature parameters, whether the historical data associated with the user relates to any service requesting activity occurred during a second predetermined time period after the reference time; upon a detection that the historical data associated with the user relates to any service requesting activity occurred during a second predetermined time period after the reference time, labeling the user as a positive sample; and upon a detection that the historical data associated with the user does not relate to any service requesting activity occurred during a second predetermined time period after the reference time, labeling the user as a negative sample. The positive sample may represent a “non-churned” user. The negative sample may represent a “churned” user.

It should be noted that, the above descriptions about user churn preventing device 500 are only for illustration purposes, and are not intended to limit the present disclosure. It is understandable that, after learning the major concept and the mechanism of the present disclosure, a person of ordinary skill in the art may alter the user churn preventing device 500 in an uncreative manner. The alteration may include combining and/or splitting modules or sub-modules, adding or removing optional modules or sub-modules, etc. All such modifications are within the protection scope of the present disclosure.

FIG. 7 is a schematic diagram illustrating an exemplary computing device. Computing device 700 may be configured to implement the user churn preventing device 500 and perform one or more operations disclosed in the present disclosure.

The computing device 700 may include a storage device 702, and a processor 704. The storage device 702 may include computer program or instructions executable by the processor 704. The storage device 702 and the processor 704 may be coupled via a bus 701. The processor 704 may be configured to execute the computer program or instructions included in the storage device 702 to implement a user churn preventing process (e.g., the process 100) described in the present disclosure.

The bus 701 may couple various components of computing device 700 and facilitate transferring of data and/or information between them. The bus 701 may have any bus structure in the art. For example, the bus 701 may include a memory bus and/or a peripheral bus.

The storage device 702 may include a memory (e.g., a read only memory (ROM), a random access memory (RAM)), a non-volatile storage device (e.g., massive storage device such as a hard disk, an optical disk, a solid-state disk, a memory card, etc.). The memory, and/or the non-volatile storage device may be configured to store computer readable instructions executable by the processor 704. The memory, and/or the non-volatile storage device may also store date and/or information generated by the processor 704 during the execution of the instructions.

In some embodiments, the storage device 702 may include a read-only memory (ROM), a random access memory (RAM), a programmable read-only memory (PROM), an erasable programmable read only memory (Erasable), a programmable read only memory (EPROM), an one-time programmable read-only Memory (OTPROM), an electronically-erasable programmable read-only memory (EEPROM), a compact disc read-only memory (CD-ROM) or other optical disc storage device, a disk storage device, a magnetic tape storage device, or any other medium readable by a computer that can carry or store data.

The processor 704 may include any processor (single-cored or multi-cored) in the art configured to execute computer readable instructions, so as to perform one or more operations or implement one or more modules/units disclosed in the present disclosure. Merely by way of example, the processor 704 may include one or more hardware processors, such as a central processing unit (CPU), an application-specific integrated circuit (ASIC), an application-specific instruction-set processor (ASIP), a graphics processing unit (GPU), a physics processing unit (PPU), a digital signal processor (DSP), a field-programmable gate array (FPGA), a programmable logic device (PLD), a controller, a microcontroller unit, a reduced instruction-set computer (RISC), a microprocessor, or the like, or any combination thereof.

In some embodiments, the computing device 700 may further include a network interface. The network interface may allow a transferring of data and/or information between a network (e.g., the network 1120) and the bus 701. For example, the network interface may include a network interface card (NIC), a Bluetooth™ module, an NFC module, etc. The processor 704 may communicate with the network interface via the bus 701.

It may be noted that, the architecture of the computing device 700 illustrated in FIG. 7 is only for demonstration purposes, and not intended to be limiting. The computing device 700 may be any device capable of performing a computation.

In some embodiments, the computing device 700 may be a single device. Alternatively, the computing device 700 may include a plurality of computing devices having a same or similar architecture as illustrated in FIG. 7, and one or more components of the computing device 700 may be implemented by one or more of the plurality of computing devices.

To implement various modules, units, and their functionalities described in the present disclosure, computer hardware platforms may be used as the hardware platform(s) for one or more of the elements described herein. A computer with user interface elements may be used to implement a personal computer (PC) or any other type of work station or terminal device. A computer may also act as a server if appropriately programmed.

FIG. 8 is a schematic diagram illustrating an exemplary process for preventing user churn according to some embodiments of the present disclosure. In some embodiments, process 800 illustrated in FIG. 8 may be implemented in the online-to-offline system 1100 illustrated in FIG. 11 (e.g., by a server 1110 as illustrated in FIG. 11). For example, the process 800 illustrated in FIG. 8 may be stored in a storage device (e.g., storage device 702, storage device 1150) in the form of instructions, and invoked and/or executed by at least one processor (e.g., processor 702 of the computing device 700 as illustrated in FIG. 7).

The process 800 may be an example for performing the operations 150 and 160 of the process 100 illustrated in FIG. 1. Some detailed descriptions of operations or elements of the process 800 may be found in the descriptions of the FIG. 1 and are not repeated herein.

In 810, the at least one processor may retrieve historical data (test historical data) associated with a first plurality of users (test users). The historical data may relate to user activities (e.g., service requesting activities) associated with an online-to-offline service platform initiated by the first plurality of users during a predetermined time period (e.g., the third time window). The first plurality of users may be all the users or some of the users of the online-to-offline service platform. For example, the first plurality of users may be all the currently active users (e.g., users having at least one user activity in the current month). As another example, the first plurality of users may be users of a certain district, within a certain age range, etc. As a further example, the first plurality of users may be users included in a certain position of a database or datasheet storing the historical data.

In 820, for a user Uᵢ of the first plurality of users, the at least one processor may determine a first feature vector Fᵢ of the user Uᵢ based on the historical data associated with the user Uᵢ. i is an integer with a maximum value as the total number of the first plurality of users and a minimum value as 1. The at least one processor may determine the first feature vector Fᵢ by extracting the aforementioned first features from the historical data associated with the user Uᵢ.

In 830, the at least one processor may determine a churn probability Pᵢ of the user Uᵢ by inputting the first feature vector Fᵢ of the user Uᵢ into a prediction model. The prediction model may be trained via the operations 110 to 140 of the process 100 illustrated in FIG. 1.

In some embodiments, the prediction model may include at least one decision tree. For example, the prediction model may include a GBDT model, a random forests model, a CART tree model, etc.

In 840, the at least one processor may assign, based on the determined churn probability Pᵢ the user Uᵢ to a group Gᵢ. The group Gᵢ may be one of a plurality of predetermined groups (the aforementioned second plurality of predetermined groups). Each of the plurality of predetermined groups may be associated with a predetermined user retention strategy.

In 850, the at least one processor may determine a user retention operation Oᵢ for the user Uᵢ based on the user retention strategy Si associated with the group Gᵢ. If the group Gᵢ represents users with a lower risk to churn (e.g., a “non-churned” group or a “low-risk” group), the user retention strategy Sᵢ may take fewer efforts on retaining the user Uᵢ. If the group Gᵢ represents users with a higher risk to churn (e.g., a “churned” group or a “high-risk” group), the user retention strategy Sᵢ may take more efforts on retaining the user Uᵢ.

In 860, the at least one processor may perform the user retention operation Oᵢ on the user Uᵢ.

In some embodiments, at least one processor may perform the whole process 800 periodically to maintain the loyalty of the users. Each performing period of the process 800 may be referred to as a user retention cycle.

In some embodiments, the at least one processor may update the prediction model periodically (e.g., via operations 110 to 140 illustrated in FIG. 1). Each updating period of the prediction model may be referred to as an updating cycle. The prediction model may be re-trained or adjusted in each updating cycle.

In some embodiments (embodiments I), the at least one processor may repeat the operations 820 to 860 (as a whole) for each user of the first plurality of users for preventing user churn of the online-to-offline service platform.

In some embodiments (embodiments II), the at least one processor may first repeat the operations 820 to 840 to assign a group for each of the first plurality of users, and then repeat the operations 850 and 860 to perform a corresponding user retention operation for each of the first plurality of user.

In some embodiments (embodiments III), the at least one processor may first repeat the operations 820 to 830 (or repeat the operation 150) to determine a churn probability for each of the first plurality of users, and then repeat the operations 840 to 860 to perform a corresponding user retention operation for each of the first plurality of user.

In some embodiments, the at least one processor may update one or more user retention strategies associated with the plurality of predetermined groups by analyzing the performances of previously performed user retention operations determined based on the one or more user retention strategies, so as to adaptively adjust the user churn preventing strategies associated with the plurality of predetermined groups and enhance the user retention performance. The operation-performing manner of the above embodiments II and III may allow an update of a user preventing strategy associated with at least one of the plurality of predetermined groups before the operation 850, so that in the current operation 860 the at least one processor may perform an optimized user retention operation. The operation-performing manner of the above embodiments I may allow an update of a user preventing strategy associated with at least one of the plurality of predetermined groups after the process 800, so that in a next user retention cycle, the at least one processor may perform an optimized user retention operation.

In some embodiments, the at least one processor may update one or more user retention strategies independently from the process 800.

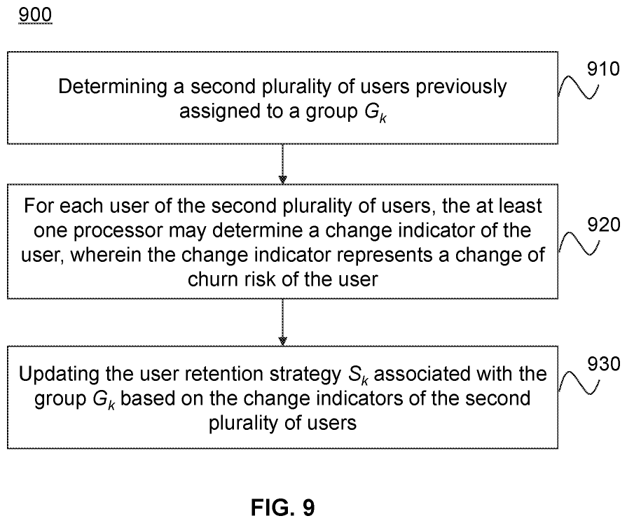

An exemplary process for updating a user retention strategy associated with a group is described in connection with FIG. 9.

It may be noted that the above descriptions of the process 800 are only for demonstration purposes, and not intended to limit the scope of the present disclosure. It is understandable that, after learning the major concept of the present disclosure, a person of ordinary skill in the art may alter the process 800 in an uncreative manner. For example, the operations above may be implemented in an order different from that illustrated in FIG. 8. One or more optional operations may be added to the flowcharts. One or more operations may be split or be combined. All such modifications are within the scope of the present disclosure.

FIG. 9 is a schematic diagram illustrating an exemplary process for updating a user retention strategy associated with a group according to some embodiments of the present disclosure. Process 900 may be performed to update a user retention strategy associated with a group. In some embodiments, process 900 illustrated in FIG. 9 may be implemented in the online-to-offline system 1100 illustrated in FIG. 11 (e.g., by a server 1110 as illustrated in FIG. 11). For example, the process 900 illustrated in FIG. 9 may be stored in a storage device (e.g., storage device 702, storage device 1150) in the form of instructions, and invoked and/or executed by at least one processor (e.g., processor 702 of the computing device 700 as illustrated in FIG. 7).

In 910, the at least one processor may determine a second plurality of users previously assigned to a group Gₖ. The group Gₖ may be one of the plurality of predetermined groups (the second plurality of predetermined groups). k is an integer with a maximum value as the total number of the plurality of predetermined groups and a minimum value as 1. The group Gₖ may be assigned to each user of the second plurality of users in a previous user retention cycle and related data or information may be included in historical data associated with the user.

The second plurality of users may be all of or some of the users of the online-to-offline platform assigned to the group Gₖ.

In 920, for each user of the second plurality of users, the at least one processor may determine a change indicator of the user. The change indicator may represent a change of churn risk of the user. For example, for a user Uⱼ of the second plurality of users, the at least one processor may determine a change indicator Cⱼ of the user Uⱼ. The change indicators of the second plurality of users may be used for a performance determination of a user retention strategy Sₖ associated with the group Gₖ.

In some embodiments, the change indicator Cⱼ may represent a change of the assigned group of the user Uⱼ. To determine the change indicator Cⱼ of the user Uⱼ, the at least one processor may obtain a currently assigned group Gⱼ of the user Uⱼ. Based on the group Gₖ and the group Gⱼ, the at least one processor may determine the change indicator Cⱼ. Merely or example, the change indicator Cⱼ may be 1 when the group Gₖ represents a “churned” group and the group Gⱼ represents a “non-churned” group, and may be −1 vice versa. As another example, the change indicator Cⱼ may be 2 when the group Gₖ represents a “high-risk” group and the group Gⱼ represents a “low-risk” group, and may be −1 when the group Gₖ represents a “low-risk” group and the group Gⱼ represents a “moderate-risk” group. As a further example, the change indicator Cⱼ may be 0 when the group Gₖ and the group Gⱼ represent a same group. It may be noted that, the change indicator Cⱼ may take other forms and the above examples are not intended to be limiting.

In some embodiments, the currently assigned group Gⱼ may also be included in historical data associated with the user Uⱼ, and the at least one processor may retrieve the group Gⱼ from the storage device.

In some embodiments, the at least one processor may determine the currently assigned group Gⱼ via operations 820 to 840. For example, the operations 820 to 840 may be included in the operation 920.

In some embodiments, the change indicator Cⱼ may represent a change of the churn probability of the user Uⱼ. To determine the change indicator Cⱼ of the user Uⱼ, the at least one processor may obtain a previously determined churn probability Pⱼ′ of the user Uⱼ and a currently determined churn probability Pⱼ of the user Uⱼ. Based on the churn probability Pⱼ′ and the churn probability Pⱼ, the at least one processor may determine the change indicator Cⱼ. Merely for example, the at least one processor may determine the change indicator Cⱼ by subtracting the churn probability Pⱼ′ from the churn probability Pⱼ.

In some embodiments, the change indicator Cⱼ may be a multi-dimensional vector (or be referred to as a change vector). The change vector may include at least one element representing the change of the churn risk of a user. In some embodiments, the change vector may further include one or more elements representing changes on other aspects of the user. For example, the change vector may include an element representing a change of the user behavior or on the user preference (e.g., a change of the traveling mode preference) of the user.

It should be noted that, the “currently” determined churn probability Pⱼ or group Gⱼ may also refer to a latest determined churn probability or group, and may not necessarily refer to a churn probability or group determined in a current user retention strategy updating process. For example, in some embodiments, the process 900 may be performed independently from the process 800 or be performed after the process 800 is completed. The churn probability Pⱼ or group Gⱼ may be a churn probability or group determined in the latest process 800 (or latest user retention cycle) and be included in a storage device (e.g., storage device 702, storage device 1150). The “previously” determined churn probability Pⱼ′ or group Gₖ may refer to a churn probability or group determined in a user retention cycle previous to the “currently” determined user retention cycle.

In 930, the at least one processor may update the user retention strategy Sₖ associated with the group Gₖ based on the change indicators of the second plurality of users. For example, the at least one processor may determine a performance parameter (first performance parameter) of the user retention strategy Sₖ based on the change indicators of the second plurality of users, and update the user retention strategy Sₖ based on the performance parameter.

The performance parameter may describe the overall performance of the user retention strategy Sₖ on the second plurality of users. Merely for demonstration purposes, the performance parameter may include a mean, a mode, a median, a variance of the change indicators of the second plurality of users, or the like, or a combination thereof.

In some embodiments, the at least one processor may update the user retention strategy based on the performance parameter and one or more thresholds (or be referred to as performance thresholds) For example, the at least one processor may compare the performance parameter with the one or more performance thresholds, and update the user retention strategy Sₖ based on the comparison results. In some embodiments, different predetermined group of the plurality of predetermined groups may be associated with a different performance threshold(s).

For example, the group Gₖ may represent a “churned” group or a “high-risk” group. The performance parameter of the associated user retention strategy Sₖ may be determined as 0.5. The one or more performance thresholds may include a floor performance threshold as 0.6. The floor performance threshold may represent a minimum acceptable value of the performance parameter. As the determined performance parameter is lower than the floor performance threshold, the at least one processor may update the user retention strategy Sₖ to enhance its performance. For example, before the update, the user retention strategy Sₖ may cause the at least one processor to perform a user retention operation offering a 20% discount for next three services on a user assigned with the group Gₖ. After the update, the updated user retention strategy Sₖ′ may cause the at least one processor to perform a user retention operation offering a 30% discount for next three days on a user assigned with the group Gₖ.

As another example, the group Gₖ may represent a “low-risk” group or a “non-churned” group. The performance parameter of the associated user retention strategy Sₖ may be determined as 0.2. The one or more performance thresholds may include a ceiling performance threshold as 0.1. The ceiling performance threshold herein may represent a maximum acceptable value of the performance parameter. As the determined performance parameter is higher than the ceiling performance threshold, the at least one processor may update the user retention strategy Sₖ to reduce its performance. For example, before the update, the user retention strategy Sₖ may cause the at least one processor to perform a user retention operation offering a 10% discount for the next three services requested by a user assigned with the group Gₖ. After the update, the updated user retention strategy Sₖ′ may cause the at least one processor to perform a user retention operation offering no discount on a user assigned with the group Gₖ.

As a further example, for the group Gₖ, when a determined performance parameter of the associated user retention strategy Sₖ is above the corresponding floor performance threshold and/or below the corresponding ceiling performance threshold. The at least one processor may not change the user retention strategy Sₖ. Such a conditional non-update may also be referred to as an update of the user retention strategy Sₖ.

In some embodiments, each group of the plurality of predetermined groups may be associated with a ceiling performance threshold and/or a floor performance threshold, and the user retention strategy associated with each group may be updated accordingly. The floor performance threshold and/or the ceiling threshold associated with the group Gₖ may be predetermined. Alternatively or additionally, the floor performance threshold and/or the ceiling threshold may be dynamically determined. For example, the floor performance threshold and/or the ceiling threshold may be based on a statistic analysis (e.g., a distribution, a rank, a mode, a mean, a median) of the corresponding performance parameters of the second plurality of users.

In some embodiments, the user retention strategy may include one or more corresponding user retention operations (e.g., in the form of a list or a datasheet). To update the user retention strategy, the at least one processor may replace at least one user retention operation in the user retention strategy associated with the predetermined group using another user retention operation. For example, the at least one processor may select at least one user retention operation to be replaced from the one or more user retention operations of the user retention strategy, and select at least one candidate user retention operation from a first collection of user retention operations (e.g., in the form of a list or a datasheet). The at least one processor may then replace the at least one user retention operation to be replaced with the at least one candidate user retention operation. The first collection of user retention operations may include all the possible user retention operations to be performed for retaining a user.

In some embodiments, each user retention operation of the first collection and the user retention strategy may be associated with an effect parameter based on an effect on retaining users of the user retention operation. For example, a user retention operation offering a 10% discount to a user for next service may have an effect parameter as 1, a user retention operation offering a 30% discount to a user for next week may have an effect parameter as 10. In some embodiments, the effect parameter may be further based on the cost or profit of the corresponding user retention operation.

The at least one processor may select the at least one user retention operation to be replaced and/or the at least one candidate user retention operation based on the associated effect parameters and the comparison result of the performance parameter and the one or more performance thresholds. In some embodiments, the at least one processor may select the at least one candidate user retention operation on an effect parameter associated with the at least one user retention operation to be replaced and the comparison result.

For example, based on the comparison result, the at least one processor may determine to enhance/reduce the effect of the user retention strategy. The at least one processor may select the at least one user retention operation to be replaced with an effect parameter as a based on, for example, first effect parameters associated with the one or more user retention operations of the user retention strategy (e.g., based on a rank, a histogram, a mean, a mode, a median of the first effect parameters). The at least one processor may then select, from the first collection, at least one candidate user retention operation having an effect parameter larger/smaller than a and replace the at least one user retention operation to be replaced with the at least one candidate user retention operation to enhance/reduce the effect of the user retention strategy.

In some embodiments, the user retention strategy may include a model or a function for determining a user retention operation. The model or the function may take the churn probability as at least a part of its input and may output a parameter related to a user retention operation to be performed. The at least one processor may update the user retention strategy by adjusting one or more parameters of the model or the function. For example, the user retention strategy may include a linear function taking the churn probability of a user as at least a part of its input and outputting an amount of discount to be offered to the user. The at least one processor may increase/reduce a coefficient of the function associated with the churn probability to enhance/reduce the effect of the user retention strategy.

Optionally, the linear function may further take one or more first feature parameters determined based on the historical data associated with the user as a part of its input.

The at least one processor may repeat the process 900 for updating user retention strategies associated with multiple groups of the plurality of predetermined groups.

It should be noted that the above descriptions of the process 900 are only for demonstration purposes, and not intended to limit the scope of the present disclosure. It is understandable that, after learning the major concept of the present disclosure, a person of ordinary skill in the art may alter the process 900 in an uncreative manner. For example, the operations above may be implemented in an order different from that illustrated in FIG. 9. One or more optional operations may be added to the flowcharts. One or more operations may be split or be combined. All such modifications are within the scope of the present disclosure.

In some embodiments, the process 900 and the process 800 (illustrated in FIG. 8) may be performed independently. The second plurality of users may include users not in the first plurality of users.

In some embodiments, the process 900 or one or more operations of the process 900 may be incorporated into the process 800, and the second plurality of users may be included in the first plurality of users of the process 800. For example, the operation 930 may be performed before the operation 850, so that the user retention strategy Sᵢ in the operation 850 is updated before the user retention operation Oᵢ is determined. As another example, operation 910 may be performed before, after, or during the process 800.

In some embodiments, the operation 910 may be performed before the operation 850 and after the operation 840.

In some embodiments, during the process 800 (e.g., before the operation 850), for the user Uᵢ of the first plurality of users, the at least one processor may determine a previously assigned group Gᵢ′ of the user Uᵢ (e.g., included in the historical data associated with the user Uᵢ), and associate the user Uᵢ with the group Gᵢ′. Accordingly, the at least one processor may traverse all the first plurality of users and determine a second plurality of users previously assigned to each group of the plurality of predetermined groups (the second plurality of predetermined groups), thereby achieving the operation 910.

In some embodiments, in the operation 850 of a previously performed process 800 (or a previous user retention cycle), for each user of at least some of the users (or be referred to as a third plurality of users) of a same group (e.g., the group Gₖ), the at least one processor may select a user retention operation from a second collection of user retention operations, and then perform the selected user retention operation on the user.

In some embodiments, the second collection of user retention operations may be the first collection of user retention operations.

In some embodiments, the second collection of user retention operations may be associated with the group Gₖ and may include user retention operations selected from the first collection of user retention operations.

In some embodiments, the second collection of user retention operations may be or be included in the list implementing the user retention strategy Sₖ associated with the group Gk.

The at least one processor may select, for each user of the third plurality of users, the user retention operation randomly or according to a predetermined pattern (e.g., each of the user retention operations in the second collection may be associated with a probability parameter representing a probability the user retention operation to be selected by the at least one processor). In some embodiments, such a selection may be based on the user retention strategy Sₖ associated with the group Gₖ.

The performed user retention operation may be included in the historical data associated with the user. Then in the operation 930 of the process 900, the at least one processor may analyze, based on the change indicators determined in the operation 920, the performance of each user retention operation with respect to users of the group Gₖ.

In some embodiments, the at least one processor may select at least one target user retention operation. For example, for each of a plurality of previously performed user retention operations associated with the group Gₖ, the at least one processor may determine a performance parameter (second performance parameter) of the previously performed user retention operation based on the change indicators associated with the previously performed user retention operation. The at least one processor may select, from the plurality of previously performed user retention operations, at least one target user retention operation based on the determined second performance parameters and one or more performance thresholds (e.g., associated with the group Gₖ). The at least one processor may then update the user retention strategy Sₖ using the at least one target user retention operation.

In some embodiments, the at least one target user retention operation may have a desired performance on the users of the group Gₖ. For example, the at least one target user retention operation may have a highest second performance parameter, have a second performance parameter have a second performance parameter equal to or most proximate to a corresponding ceiling/floor updating threshold. The at least one processor may update the user retention strategy Sₖ to cause the at least one target user retention operation to be performed on more users (or all the users) of the group Gₖ. For example, the at least one processor may replace at least one user retention operation included in a list implementing the user retention strategy Sₖ with the at least one target user retention operation. As another example, the at least one processor may add the at least one target user retention operation into the list implementing the user retention strategy Sₖ. As a further example, the at least one processor may increase the probability that the at least one target user retention operation selected from the second collection. Still as a further example, the at least one processor may user the at least one target user retention operation as a supervisory output for training or adjusting a model or function implementing the user retention strategy Sₖ.

In some embodiments, the at least one target user retention operation may have an undesired performance on the users of the group Gₖ. For example, the at least one target user retention operation may have a lowest performance parameter or have a performance parameter above/below a corresponding ceiling/floor updating threshold. The at least one processor may update the user retention strategy Sₖ to cause the at least one target user retention operation to be performed on fewer users of the group Gₖ. For example, the at least one may remove a user retention operation included in a list implementing the user retention strategy Sₖ corresponding to the at least one target user retention operation. As another example, the at least one processor may decrease the probability that the at least one target user retention operation selected from the second collection.

In some embodiments, the at least one processor may determine an effect parameter for each user retention operation of the second collection with respect to users of the group Gₖ based on the performance parameter of the user retention operation. The determined effect parameters may be used for enhancing or reducing the effect of the user retention strategy Sₖ in the operation 930 as described before. In some embodiments, the at least one processor may periodically updating the effect parameters associated with the user retention operations of the second collection.

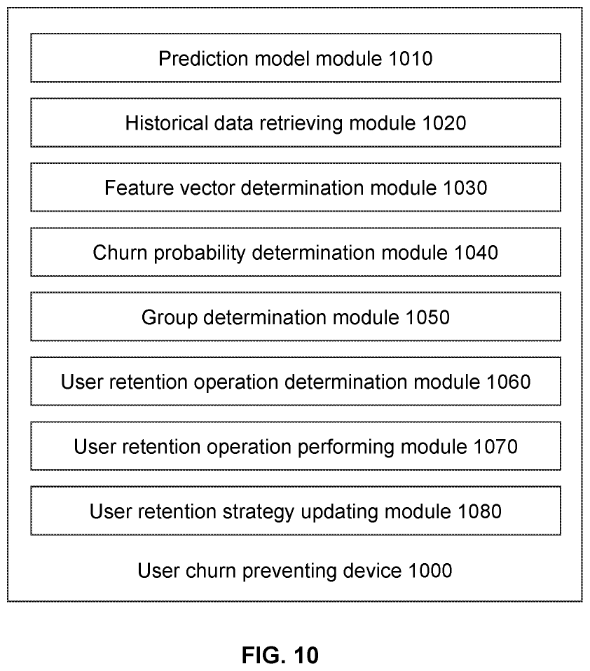

FIG. 10 is a schematic diagram illustrating an exemplary user churn preventing device according to some embodiments of the present disclosure. User churn preventing device 1000 may include a prediction model module 1010, a historical data retrieving module 1020, a feature vector determination module 1030, a churn probability determination module 1040, a group determination module 1050, a user retention operation determination module 1060, a user retention operation performing module 1070, and a user retention strategy updating module 1080. In some embodiments, the user churn preventing device 500 or one or more of its modules may be implemented by at least one processor (e.g., the processor 702) to perform the process 800 illustrated in FIG. 8.

The prediction model module 1010 may obtain a prediction model for determining a churn probability of a user.

In some embodiments, the prediction model module 1010 may train the prediction model via operations described in the present disclosure (e.g., operations 110 to 140, operations 310 to 316, operations 402 to 408). For example, the prediction model 1010 may include the retrieving module 502, the extraction module 504, the labeling module 506, and the training module 508. As another example, the prediction model 1010 may further include the setting module 516, the determination module 518, and the detection module 520.

In some embodiments, the prediction model module 1010 may directly retrieve a trained model from a storage device (e.g., storage device 702, storage device 1150) or via a network (e.g., the network 1120).

The historical data retrieving module 1020 may retrieve historical data associated with a first plurality of users. In some embodiments, the historical data may relate to user activities associated with an online-to-offline service platform initiated by the first plurality of users during a predetermined time period. The historical data retrieving module 1020 may perform the operation 810 illustrated in FIG. 8.

The feature vector determination module 1030 may determine, for each user of the first plurality of users, a first feature vector of the user based on the historical data associated with the user. The feature vector determination module 1030 may perform the operation 820 illustrated in FIG. 8.

The churn probability determination module 1040 may determine, for each user of the first plurality of users, a churn probability of the user by inputting the first feature vector of the user into the prediction model. The churn probability determination module 1040 may perform the operation 830 illustrated in FIG. 8.

In some embodiments, the historical data retrieving module 1020, the feature vector determination module 1030, and the churn probability determination module 1040 may be included in the prediction module 510 illustrated in FIG. 5.

The group determination module 1050 may assign, for each user of the first plurality of users, based on the determined churn probability of the user, the user to one of a plurality of predetermined groups, each of which is associated with a user retention strategy. The group determination module 1050 may perform the operation 840 illustrated in FIG. 8.

The user retention operation determination module 1060 may determine, for each user of the first plurality of users, a user retention operation for the user based on the user retention strategy associated with the predetermined group that the user is assigned to. The user retention operation determination module 1060 may perform the operation 850 illustrated in FIG. 8.

The user retention operation performing module 1070 may perform, for each user of the first plurality of users, the user retention operation on the user. The user retention operation performing module 1070 may perform the operation 860 illustrated in FIG. 8.

In some embodiments, the group determination module 1050, the user retention operation determination module 1060, and the user retention operation performing module 1070 may be included in the execution module 512 illustrated in FIG. 5.

The user retention strategy updating module 1080 may update user retention strategies associated with one or more groups of the plurality of predetermined group. The user retention strategy updating module 1080 may perform the process 900 illustrated in FIG. 9. In some embodiments, the user retention strategy updating module 1080 may be optional.

It may be noted that, the above descriptions about the user churn preventing device 1000 are only for illustration purposes, and are not intended to limit the present disclosure. It is understandable that, after learning the major concept and the mechanism of the present disclosure, a person of ordinary skill in the art may alter the user churn preventing device 1000 in an uncreative manner. The alteration may include combining and/or splitting modules or sub-modules, adding or removing optional modules or sub-modules, etc. All such modifications are within the protection scope of the present disclosure.

FIG. 11 is a schematic diagram illustrating an exemplary online-to-offline service system according to some embodiments of the present disclosure. For example, an online-to-offline service system 1100 may implement an online-to-offline service platform providing transportation services such as taxi hailing, chauffeur services, delivery service, carpool, bus service, take-out service, driver hiring and shuttle services. For brevity, the methods and/or systems described in the present disclosure may take a taxi service as an example. It should be noted that the taxi service is merely provided for the purposes of illustration, and not intended to limit the scope of the present disclosure. For persons having ordinary skills in the art, the methods and/or systems described in the present disclosure may be applied to other similar situations, such as a take-out service, a delivery service, etc.

The online-to-offline service system 1100 may include a server 1110, a network 1120, a requester terminal 1130, a provider terminal 1140, a storage device 1150, and a positioning system 1160. The online-to-offline service system 1100 may be configured to implement the methods for preventing user churn described in the present disclosure.

In some embodiments, the server 1110 may be a single server or a server group. The server group may be centralized, or distributed (e.g., the server 1110 may be a distributed system). In some embodiments, the server 1110 may be local or remote. For example, the server 1110 may access information and/or data stored in the requester terminal 1130, the provider terminal 1140, and/or the storage device 1150 via the network 1120. As another example, the server 1110 may be directly connected to the requester terminal 1130, the provider terminal 1140, and/or the storage device 1150 to access stored information and/or data. In some embodiments, the server 1110 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof.

In some embodiments, the server 1110 may include a processing engine 1112. The processing engine 1112 may process information and/or data relating to the online-to-offline service. In some embodiments, the server 1110 may have a structure the same as or similar to that of the computing device 700 as illustrated in FIG. 7. For example, the processing engine 1112 may include one or more processors (e.g., the processor 704) and one or more storage devices (e.g., the storage device 702).

In some embodiments, the one or more processor included in the processing engine 1112 may implement a user churn preventing device described in the present disclosure (e.g., the user churn preventing devices 500, and 1000) and perform a corresponding user churn preventing process (e.g., processes 100, and 800).

The network 1120 may facilitate the exchange of information and/or data. In some embodiments, one or more components in the online-to-offline service system 1140 (e.g., the server 1110, the requester terminal 1130, the provider terminal 1140, the storage device 1150, and the positioning system 1160) may send information and/or data to other component(s) in the online-to-offline service system 1140 via the network 1120. For example, the server 1110 may obtain/acquire a service request from the requester terminal 1130 via the network 1120. In some embodiments, the network 1120 may be any type of wired or wireless network, or a combination thereof. Merely by way of example, the network 1130 may include a cable network, a wireline network, an optical fiber network, a telecommunications network, an intranet, the Internet, a local area network (LAN), a wide area network (WAN), a wireless local area network (WLAN), a metropolitan area network (MAN), a wide area network (WAN), a public telephone switched network (PSTN), a cellular network, a Bluetooth™ network, a ZigBee network, a near field communication (NFC) network, or the like, or any combination thereof. In some embodiments, the network 1120 may include one or more network access points. For example, the network 1120 may include wired or wireless network access points such as base stations and/or internet exchange points 1120-1, 1120-2, . . . , through which one or more components of the online-to-offline service system 1100 may be connected to the network 1120 to exchange data and/or information.

In some embodiments, a requester may be a user of the requester terminal 1130. In some embodiments, the user of the requester terminal 1130 may be someone other than the requester. For example, a user A of the requester terminal 1130 may use the requester terminal 1130 to send a service request for a user B, or receive service and/or information or instructions from the server 1110. In some embodiments, a provider may be a user of the provider terminal 1140. In some embodiments, the user of the provider terminal 1140 may be someone other than the provider. For example, a user C of the provider terminal 1140 may user the provider terminal 1140 to receive a service request for a user D, and/or information or instructions from the server 1110.

In some embodiments, the requester terminal 1130 may include a mobile device 1130-1, a tablet computer 1130-2, a laptop computer 1130-3, a built-in device in a motor vehicle 1130-4, or the like, or any combination thereof. In some embodiments, the mobile device 1130-1 may include a smart home device, a wearable device, a mobile device, a virtual reality device, an augmented reality device, or the like, or any combination thereof. In some embodiments, the smart home device may include a control device of an intelligent electrical apparatus, a smart monitoring device, a smart television, a smart video camera, an interphone, or the like, or any combination thereof. In some embodiments, the wearable device may include a bracelet, footgear, glasses, a helmet, a watch, clothing, a backpack, a smart accessory, or the like, or any combination thereof. In some embodiments, the mobile device may include a mobile phone, a personal digital assistance (PDA), a gaming device, a navigation device, a point of sale (POS) device, a laptop, a desktop, or the like, or any combination thereof. In some embodiments, the virtual reality device and/or the augmented reality device may include a virtual reality helmet, a virtual reality glass, a virtual reality patch, an augmented reality helmet, augmented reality glasses, an augmented reality patch, or the like, or any combination thereof. For example, the virtual reality device and/or the augmented reality device may include a Google Glass™, a RiftCon™, a Fragments™, a Gear VR™, etc. In some embodiments, the built-in device in the motor vehicle 1130-4 may include an onboard computer, an onboard television, etc. In some embodiments, the requester terminal 1130 may be a device with positioning technology for locating the position of a user of the requester terminal 1130 (e.g., a service requester) and/or the requester terminal 1130.

In some embodiments, the provider terminal 1140 may be a device that is similar to, or the same as the requester terminal 1130. For example, the provider terminal 1140 may also be or include a mobile device 1140-1, a tablet computer 1140-2, a laptop computer 1140-3, a built-in device in a motor vehicle 1140-4, which are the same as or similar to the mobile device 1130-1, the tablet computer 1130-2, the laptop computer 1130-3, the built-in device in a motor vehicle 1130-4. In some embodiments, the provider terminal 1140 may be a device utilizing positioning technology for locating the position of a user of the provider terminal 1140 (e.g., a service provider) and/or the provider terminal 1140. In some embodiments, the requester terminal 1130 and/or the provider terminal 1140 may communicate with one or more other positioning devices to determine the position of the requester, the requester terminal 1130, the provider, and/or the provider terminal 1140. In some embodiments, the requester terminal 1130 and/or the provider terminal 1140 may send positioning information to the server 1110.

The storage device 1150 may store data and/or instructions. In some embodiments, the storage device 1150 may store data obtained from the requester terminal 1130 and/or the provider terminal 1140. In some embodiments, the storage device 1150 may store data and/or instructions that the server 1110 may execute or use to perform exemplary methods described in the present disclosure. In some embodiments, the storage device 1150 may include a mass storage, a removable storage, a volatile read-and-write memory, a read-only memory (ROM), or the like, or any combination thereof. Exemplary mass storage may include a magnetic disk, an optical disk, a solid-state drive, etc. Exemplary removable storage may include a flash drive, a floppy disk, an optical disk, a memory card, a zip disk, a magnetic tape, etc. Exemplary volatile read-and-write memory may include a random access memory (RAM). Exemplary RAM may include a dynamic RAM (DRAM), a double date rate synchronous dynamic RAM (DDR SDRAM), a static RAM (SRAM), a thyrisor RAM (T-RAM), and a zero-capacitor RAM (Z-RAM), etc. Exemplary ROM may include a mask ROM (MROM), a programmable ROM (PROM), an erasable programmable ROM (EPROM), an electrically-erasable programmable ROM (EEPROM), a compact disk ROM (CD-ROM), and a digital versatile disk ROM, etc. In some embodiments, the storage device 1150 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof.

In some embodiments, the storage device 1150 may be connected to the network 1120 to communicate with one or more components in the online-to-offline service system 1140 (e.g., the server 1110, the requester terminal 1130, the provider terminal 1140, etc.). One or more components in the online-to-offline service system 1400 may access the data or instructions stored in the storage device 1150 via the network 1120. In some embodiments, the storage device 1150 may be directly connected to or communicate with one or more components in the online-to-offline service system 1140 (e.g., the server 1110, the requester terminal 1130, the provider terminal 1140, etc.). In some embodiments, one or more components in the online-to-offline service system 1140 (e.g., the server 1110, the requester terminal 1130, the provider terminal 1140, etc.) may have permission to access the storage device 1150. In some embodiments, the storage device 1150 may be part of the server 1110.

The positioning system 1160 may determine information associated with an object, for example, the requester terminal 1130, the provider terminal 1140, etc. For example, the positioning system 1160 may determine a current location of the requester terminal 1130. In some embodiments, the positioning system 1160 may be a global positioning system (GPS), a global navigation satellite system (GLONASS), a compass navigation system (COMPASS), a BeiDou navigation satellite system, a Galileo positioning system, a quasi-zenith satellite system (QZSS), etc. The information may include a location, an elevation, a velocity, or an acceleration of the object, or a current time. The location may be in the form of coordinates, such as, latitude coordinate and longitude coordinate, etc. The positioning system 1160 may include one or more satellites, for example, a satellite 1160-1, a satellite 1160-2, and a satellite 1160-3. The satellites 1160-1 through 1160-3 may determine the information mentioned above independently or jointly. The satellite positioning system 1160 may send the information mentioned above to the network 1120, the requester terminal 1130, or the provider terminal 1140 via wireless connections.

In some embodiments, information exchanging of one or more components in the online-to-offline service system 1140 may be achieved by way of requesting a service. The object of the service request may be any product. In some embodiments, the product may be a tangible product or an immaterial product. The tangible product may include food, medicine, commodity, chemical product, electrical appliance, clothing, car, housing, luxury, or the like, or any combination thereof. The immaterial product may include a servicing product, a financial product, a knowledge product, an internet product, or the like, or any combination thereof. The internet product may include an individual host product, a web product, a mobile internet product, a commercial host product, an embedded product, or the like, or any combination thereof. The mobile internet product may be used in a software of a mobile terminal (e.g., a mobile application), a program, a system, or the like, or any combination thereof. For example, the product may be any software and/or application used in the computer or mobile phone. The software and/or application may relate to socializing, shopping, transporting, entertainment, learning, investment, or the like, or any combination thereof. In some embodiments, the software and/or application relating to transporting may include a traveling software and/or application, a vehicle scheduling software and/or application, a mapping software and/or application, etc. In the vehicle scheduling software and/or application, the vehicle may include a horse, a carriage, a rickshaw (e.g., a wheelbarrow, a bike, a tricycle, etc.), a car (e.g., a taxi, a bus, a private car, etc.), a vessel, an aircraft (e.g., an airplane, a helicopter, an unmanned aerial vehicle (UAV)), or the like, or any combination thereof.

It may be noted that, the online-to-offline service system 1100 is only provided for demonstration, and not intended to be limiting. The heading determination method and the corresponding system described in the present disclosure may have other application scenarios. For example, the heading determination method may also be applied for determining a heading of a private car (or another type of vehicle).

It should be noted that, the term “user” in the present disclosure is not limited to a user to request a service (e.g., a user of a requester terminal 1130, a customer, a service requester, a passenger), but may also related to a user to provide a service (e.g., a user of a provider terminal 1140, a shop keeper, a service provider, a driver). For example, the server 110 or any other server of the online-to-offline service platform may also determine a risk of a registered service provider to churn for an alternative online-to-offline service platform, and perform a user retention operation on the service provider based on a corresponding user retention strategy. The user retention operation to be performed on a service provider may also be intended to reduce the churn risk of the service provider. For example, the user retention operation to be performed on a service provider may offer more share to the service provider whenever a service is successfully completed, charge less fee on platform services (e.g., advertisement, platform usage), provide free platform services for a predetermined time period, provider more/premium service requesting orders, etc.

In some embodiments, via a user preventing process (e.g., the processes 100 and 800) described in the present disclosure, the server 1110 or the processing engine 1112 may perform a user retention operation on a user E of a mobile device (the requester terminal 1140 or the provider terminal 1150). The server 1110 may provide data to be executed by the mobile device of the user E, and transmit the data to the mobile device 1130 via the network 1120. The data, after executed by the mobile device of the user E, may cause the mobile device or an online-to-offline service application implemented in the mobile computing device to generate a presentation (e.g., as illustrated in FIGS. 15 and 16) on the display of the mobile device. The presentation may include information intended to reduce the churn risk of the user E.

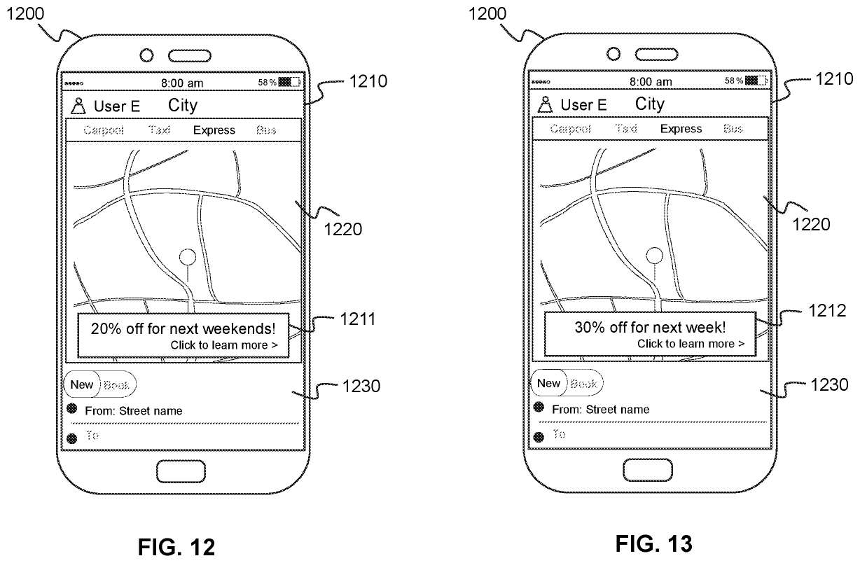

FIGS. 12 and 13 are schematic diagram illustrating an exemplary presentation including information for reducing the churn risk of a user according to some embodiments of the present disclosure. Mobile phone 1200 may be an example of the mobile device of the user E and may include at least one processor (e.g., the processor 704) and at least one storage device (e.g., the storage device 702). The at least one storage device may include an online-to-offline service application (or executable instructions) related to the online-to-offline service platform implemented by the online-to-offline system 1100. When executing the online-to-offline service application, the at least one processor may cause the mobile phone 1200 to generate an interface 1210 on the display of the mobile phone 1200.

In some embodiments, the interface 1210 may include a map 1220, and may depict the current location of the user E (or the requester terminal 1130 of the user E). The interface 1210 may also include an operation region 1230 to provide an input mean for the user E.

The data provided by the server 110 may cause the interface 1210 to generate a presentation (e.g., presentations 1211 and 1212). The presentation may include information intended to reduce the churn risk of the user E. For example, the information may offer a discount for the user E for a predetermined time, or inform the user E with a coming sales promotion.

In some embodiments, the presentation may be displayed above the map 1220 and/or the operating region 1230 of the interface 1210, so that the information included in the presentation may be more noticeable.

At a first time point (e.g., on Jun. 1, 2017), via operations in the process 100 or 800, the server 110 may assign the user E with a group A representing potentially churned users (e.g., a “churned” group, a “high-risk” group, or a “moderate-risk” group). Based on user retention strategy A associated with the group A, the server 110 may determine a first user retention operation to be performed on the user E, and provide first data corresponding to the first user retention operation to the user E. The first data may cause the interface 1210 to generate the presentation 1211.

Then at a second time point (e.g., on Sep. 1, 2017) which is after the first time point, via operations in the process 100 or 800, the server 110 may still assign the user E with the group A. However, the server 110 may have updated the user retention strategy (resulting in an updated user retention strategy A′) associated with the group A via operations in the process 900. Based on the updated user retention strategy A′ associated with the group A, the server 110 may determine a second user retention operation to be performed on the user E, and provide second data corresponding to the second user retention operation to the user E. The second data may cause the interface 1210 to generate the presentation 1212.

For example, in the process 900, the server 110 may determine that the performance of the user retention strategy A on user retention is insufficient on retaining users. The server 110 may then update the user retention strategy A to enhance its performance and obtain the updated user retention strategy A′. As a result, as illustrated in FIGS. 12 and 13, the presentation 1212 may include information taking more efforts on retaining users (e.g., offering a higher discount, providing more sales promotions, offering more share) compared to the presentation 1211.

As another example, in the process 900, the server 110 may determine that the performance of the user retention strategy A on user retention is too much to profit. The server 110 may then update the user retention strategy A to reduce its performance and obtain the updated user retention strategy A″. As a result (not shown), the presentation 1212 may include information taking less efforts on retaining users (e.g., offering a lower discount, providing less sales promotions, offering less share) compared to the presentation 1211.

Having thus described the basic concepts, it may be rather apparent to those skilled in the art after reading this detailed disclosure that the foregoing detailed disclosure may be intended to be presented by way of example only and may be not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment may be included in at least one embodiment of the present disclosure. Therefore, it may be emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “unit,” “module,” or “system.” Furthermore, aspects of the present disclosure may take the form of a computer program product embodied in one or more computer readable media having computer readable program code embodied thereon.

A computer readable signal medium may include a propagated data signal with computer readable program code embodied therein, for example, in baseband or as part of a carrier wave. Such a propagated signal may take any of a variety of forms, including electro-magnetic, optical, or the like, or any suitable combination thereof. A computer readable signal medium may be any computer readable medium that may be not a computer readable storage medium and that may communicate, propagate, or transport a program for use by or in connection with an instruction execution system, apparatus, or device. Program code embodied on a computer readable signal medium may be transmitted using any appropriate medium, including wireless, wireline, optical fiber cable, RF, or the like, or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB. NET, Python or the like, conventional procedural programming languages, such as the “C” programming language, Visual Basic, Fortran 2103, Perl, COBOL 2102, PHP, ABAP, dynamic programming languages such as Python, Ruby, and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Furthermore, the recited order of processing elements or sequences, or the use of numbers, letters, or other designations therefore, may be not intended to limit the claimed processes and methods to any order except as may be specified in the claims. Although the above disclosure discusses through various examples what may be currently considered to be a variety of useful embodiments of the disclosure, it may be to be understood that such detail may be solely for that purposes, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, for example, an installation on an existing server or mobile device.

Similarly, it should be appreciated that in the foregoing description of embodiments of the present disclosure, various features are sometimes grouped together in a single embodiment, figure, or description thereof for the purposes of streamlining the disclosure aiding in the understanding of one or more of the various inventive embodiments. This method of disclosure, however, may be not to be interpreted as reflecting an intention that the claimed subject matter requires more features than are expressly recited in each claim. Rather, inventive embodiments lie in less than all features of a single foregoing disclosed embodiment.

In some embodiments, the numbers expressing quantities or properties used to describe and claim certain embodiments of the application are to be understood as being modified in some instances by the term “about,” “approximate,” or “substantially.” For example, “about,” “approximate,” or “substantially” may indicate ±20% variation of the value it describes, unless otherwise stated. Accordingly, in some embodiments, the numerical parameters set forth in the written description and attached claims are approximations that may vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the application are approximations, the numerical values set forth in the specific examples are reported as precisely as practicable.

Each of the patents, patent applications, publications of patent applications, and other material, such as articles, books, specifications, publications, documents, things, and/or the like, referenced herein may be hereby incorporated herein by this reference in its entirety for all purposes, excepting any prosecution file history associated with same, any of same that may be inconsistent with or in conflict with the present document, or any of same that may have a limiting affect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the application disclosed herein are illustrative of the principles of the embodiments of the application. Other modifications that may be employed may be within the scope of the application. Thus, by way of example, but not of limitation, alternative configurations of the embodiments of the application may be utilized in accordance with the teachings herein. Accordingly, embodiments of the present application are not limited to that precisely as shown and describe.

1-4. (canceled)

5. A system for preventing user churn in an online-to-offline service platform, comprising:
at least one network interface to communicate with a plurality of mobile computing devices via a network;
one or more storage devices implementing at least one database;
at least one processor in communication with the at least one network interface and configured to:
retrieve historical data associated with a first plurality of users, wherein the historical data relates to user activities initiated by the first plurality of users during a predetermined time period;
for each user of the first plurality of users,
determine a first feature vector of the user based on the historical data associated with the user;
determine a churn probability of the user by inputting the first feature vector of the user into a prediction model;
assign, based on the determined churn probability of the user, the user to one of a plurality of predetermined groups, each of which is associated with a user retention strategy;
determine a user retention operation for the user based on the user retention strategy associated with the predetermined group that the user is assigned to; and
perform the user retention operation on the user, wherein the user retention operation includes providing one or more promotions to use the online-to-offline service via a user interface of an online-to-offline service application implemented in a terminal device of the user.

6. The system of claim 5, wherein the at least one processor is configured further to, for each of one or more of the plurality of predetermined groups:
determine a second plurality of users previously assigned to the predetermined group;
determine, for each user of the second plurality of users, a change indicator of the user, the change indicator representing a change of churn risk of the user; and
update the user retention strategy associated with the predetermined group based on the change indicators of the second plurality of users and one or more performance thresholds.

7. The system of claim 6, wherein the change indicator represents a change of the group of the user or a change of the churn probability of the user, and the second plurality of users are included in the first plurality of users.

8-9. (canceled)

10. The system of claim 6, wherein to update the user retention strategy associated with the predetermined group based on the change indicators of the second plurality of user and one or more performance thresholds, the at least one processor is configured to:
determine a first performance parameter of the user retention strategy associated with the predetermined group based on the change indicators of the second plurality of users;
compare the first performance parameter with the one or more performance thresholds; and
update the user retention strategy based on the comparison results.

11. The system of claim 10, wherein:
the user retention strategy includes one or more user retention operations; and
to update the user retention strategy based on the comparison results, the at least one processor is configured to:
replace at least one user retention operation in the user retention strategy associated with the predetermined group using another user retention operation.

12. The system of claim 10, wherein to update the user retention strategy associated with the predetermined group based on the change indicators of the second plurality of users and one or more performance thresholds, the at least one processor is configured further to:
for each of a plurality of previously performed user retention operations associated with the predetermined group:
determine a second performance parameter of the previously performed user retention operation based on the change indicators associated with the previously performed user retention operation;
select, from the plurality of previously performed user retention operations, at least one target user retention operation based on the second performance parameters and the one or more performance thresholds; and
replace at least one user retention operation in the user retention strategy associated with the predetermined group using the at least one target user retention operation.

13. The system of claim 5, wherein to assign, based on the determined churn probability of the user, the user to one of the plurality of predetermined groups, the at least one processor is configured to:
determine one or more probability thresholds;
determine at least one performance indicator of the prediction model;
determine a target range for the at least one performance indicator;
adaptively adjust the one or more probability thresholds, so that the at least one performance indicator is within the at least one target range;
compare the determined churn probability of the user with the one or more probability thresholds; and
assign the user to one of the plurality of predetermined groups based on the comparison result.

14. (canceled)

15. The system of claim 13, wherein the at least one performance indicator includes at least one of an accuracy, a precision, or a recall of the prediction model.

16. The system of claim 5, wherein the at least one processor is configured further to:
retrieve historical data related to user activates of a plurality of sampled users;
for each user of the plurality of sampled users,
determine, a plurality of first feature parameters and at least one second feature parameter of the user based on the historical data, wherein the plurality of first feature parameters forms a second feature vector of the user; and
assign a label to the user based at least on the at least one second feature parameter;
and
obtain the prediction model by training a preliminary prediction model using the second feature vectors of the plurality of sampled users as inputs and the labels of the plurality of sampled users as supervisory outputs.

17. The system of claim 16, wherein the at least one processor is configured further to assign the label to the user based further on one or more of the plurality of first feature parameters, wherein:
the historical data includes first data and second data;
the first data relates to user activities initiated by the plurality of sampled users within a first time window;
the second data relates to user activities initiated by the plurality of sampled users within a second time window after the first time window;
the plurality of first feature parameters is determined based on the first data; and
the at least one second feature parameter is determined based on the second data.

18-19. (canceled)

20. A method for preventing user churn, implemented on at least one device, each of which includes at least one network interface to communicate with a plurality of mobile computing devices via a network, one or more storage devices implementing at least one database, and at least one processor in communication with the at least one network interface, the method comprising:
retrieving, by the at least one processor, historical data associated with a first plurality of users, wherein the historical data relates to user activities initiated by the first plurality of users during a predetermined time period;
for each user of the first plurality of users,
determining, by the at least one processor, a first feature vector of the user based on the historical data associated with the user;
determining, by the at least one processor, a churn probability of the user by inputting the first feature vector of the user into a prediction model;
assigning, by the at least one processor based on the determined churn probability of the user, the user to one of a plurality of predetermined groups, each of which is associated with a user retention strategy;
determining, by the at least one processor, a user retention operation for the user based on the user retention strategy associated with the predetermined group that the user is assigned to; and
performing, by the at least one processor, the user retention operation on the user, wherein the user retention operation includes providing one or more promotions to use the online-to-offline service via a user interface of an online-to-offline service application implemented in a terminal device of the user.

21. The method of claim 20, further comprising:
for each of one or more of the plurality of predetermined groups:
determining a second plurality of users previously assigned to the predetermined group;
determining, for each user of the second plurality of users, a change indicator of the user, the change indicator representing a change of churn risk of the user; and
updating the user retention strategy associated with the predetermined group based on the change indicators of the second plurality of users and one or more performance thresholds.

22. The method of claim 21, wherein the change indicator represents a change of the group of the user or a change of the churn probability of the user, and the second plurality of users is included in the first plurality of users.

23-24. (canceled)

25. The method of claim 21, wherein the updating the user retention strategy associated with the predetermined group based on the change indicators of the second plurality of user and one or more performance thresholds comprises:
determining a first performance parameter of the user retention strategy associated with the predetermined group based on the change indicators of the second plurality of users;
comparing the first performance parameter with the one or more performance thresholds; and
updating the user retention strategy based on the comparison results.

26. The method of claim 25, wherein:
the user retention strategy includes one or more user retention operations; and
the updating the user retention strategy based on the comparison results comprises:
replacing at least one user retention operation in the user retention strategy associated with the predetermined group using another user retention operation.

27. The method of claim 25, wherein the updating the user retention strategy associated with the predetermined group based on the change indicators of the second plurality of users and one or more performance thresholds comprises:
for each of a plurality of previously performed user retention operations associated with the predetermined group:
determining a second performance parameter of the previously performed user retention operation based on the change indicators associated with the previously performed user retention operation;
selecting, from the plurality of previously performed user retention operations, at least one target user retention operation based on the second performance parameters and the one or more performance thresholds; and
replacing at least one user retention operation in the user retention strategy associated with the predetermined group using the at least one target user retention operation.

28. The method of claim 20, wherein the assigning, based on the determined churn probability of the user, the user to one of the plurality of predetermined groups comprises:
determining one or more probability thresholds;
determine at least one performance indicator of the prediction model, wherein the at least one performance indicator includes at least one of an accuracy, a precision, or a recall of the prediction model;
determine a target range for the at least one performance indicator;
adaptively adjust the one or more probability thresholds, so that the at least one performance indicator is within the at least one target range;
comparing the determined churn probability of the user with the one or more probability thresholds; and
assigning the user to one of the plurality of predetermined groups based on the comparison result.

29-30. (canceled)

31. The method of claim 20, further comprising:
retrieving historical data related to user activates of a plurality of sampled users;
for each user of the plurality of sampled users,
determining, a plurality of first feature parameters and at least one second feature parameter of the user based on the historical data, wherein the plurality of first feature parameters forms a second feature vector of the user; and
assigning a label to the user based at least on the at least one second feature parameter;
and
obtaining the prediction model by training a preliminary prediction model using the second feature vectors of the plurality of sampled users as inputs and the labels of the plurality of sampled users as supervisory outputs.

32. The method of claim 31, further comprising:
assigning the label to the user based further on one or more of the plurality of first feature parameters wherein:
the historical data includes first data and second data;
the first data relates to user activities initiated by the plurality of sampled users within a first time window;
the second data relates to user activities initiated by the plurality of sampled users within a second time window after the first time window;
the plurality of first feature parameters is determined based on the first data; and
the at least one second feature parameter is determined based on the second data.

33-34. (canceled)

35. A non-transitory computer readable medium, storing instructions, the instructions, when executed by a processor, causing the processor to execute operations comprising:
retrieving historical data associated with a first plurality of users, wherein the historical data relates to user activities initiated by the first plurality of users during a predetermined time period;
for each user of the first plurality of users,
determining a first feature vector of the user based on the historical data associated with the user;
determining a churn probability of the user by inputting the first feature vector of the user into a prediction model;
assigning, based on the determined churn probability of the user, the user to one of a plurality of predetermined groups, each of which is associated with a user retention strategy;
determining a user retention operation for the user based on the user retention strategy associated with the predetermined group that the user is assigned to; and
performing the user retention operation on the user, wherein the user retention operation includes providing one or more promotions to use the online-to-offline service via a user interface of an online-to-offline service application implemented in a terminal device of the user.
